(19) United States
(12) Patent Application Publication
(10) Pub. No.: US 2021/0370493 A1
(43) Pub. Date: Dec. 2, 2021

(54) DIRECT DRIVE PNEUMATIC TRANSMISSION FOR A MOBILE ROBOT

(71) Applicant: ROAM ROBOTICS INC., San Francisco, CA (US)

(72) Inventors: Elias R. Samia, San Francisco, CA (US); Linus Park, Pacifica, CA (US); Kevin Conrad Kemper, San Francisco, CA (US); Timothy Alan Swift, Walnut Creek, CA (US); Philip le Roux, Berkeley, CA (US); Randy Dzioba, Berkeley, CA (US)

(21) Appl. No.: 17/329,632

(22) Filed: May 25, 2021

Related U.S. Application Data
(60) Provisional application No. 63/030,551, filed on May 27, 2020.
(60) Provisional application No. 63/146,390, filed on Feb. 5, 2021.

(51) Int. Cl. B25J 9/00; B25J 9/14; B25J 13/08; B25J 19/00

(52) U.S. Cl. CPC B25J 9/0006; B25J 9/144; B25J 19/0029; B25J 13/087; B25J 9/142

(57) ABSTRACT

An exoskeleton system comprising a fluidic actuator and a power transmission that includes: a transmission body that defines a transmission chamber configured to hold a fluid, the transmission body having a first and second end, and a piston that translates within the transmission chamber between the first and second ends of the transmission body, with translation of the piston within the transmission chamber changing a volume of the transmission chamber. The exoskeleton system also includes a mechanical power source coupled to the power transmission configured to cause the piston to translate within respective transmission body to change the volume of the transmission cavity; and a first fluid line that couples the power transmission to the fluidic actuator.

### CROSS-REFERENCE TO RELATED APPLICATIONS

This application is a non-provisional of and claims priority to U.S. Provisional Patent Application No. 63/030,551, filed May 27, 2020, entitled “DYNAMIC AIR DISPLACEMENT PRESSURE CONTROL FOR A CLOSED SYSTEM,” with attorney docket number 0110496-009PR0. This application is hereby incorporated herein by reference in its entirety and for all purposes.

This application is also a non-provisional of and claims priority to U.S. Provisional Patent Application No. 63/146,390, filed Feb. 5, 2021, entitled “DIRECT DRIVE PNEUMATIC TRANSMISSION FOR MOBILE ROBOT,” with attorney docket number 0110496-009PR1. This application is hereby incorporated herein by reference in its entirety and for all purposes.

### BRIEF DESCRIPTION OF THE DRAWINGS

FIG. 1 is an example illustration of an embodiment of an exoskeleton system being worn by a user.

FIG. 2 is a front view of an embodiment of a leg actuation unit coupled to one leg of a user.

FIG. 3 is a side view of the leg actuation unit of FIG. 3 coupled to the leg of the user.

FIG. 4 is a perspective view of the leg actuation unit of FIGS. 3 and 4.

FIG. 5 is a block diagram illustrating an example embodiment of an exoskeleton system.

FIG. 6 illustrates one example embodiment of a pneumatic power transmission that can be part of a pneumatic system of an exoskeleton system.

FIG. 7a illustrates an example of a pneumatic power transmission in a first configuration where the piston is at a first position within the transmission body along the length of the lead screw.

FIG. 7b illustrates an example of the pneumatic power transmission of FIG. 7a in a second configuration where the piston is at a second position within the transmission body along the length of the lead screw.

FIG. 8 illustrates another embodiment of a pneumatic transmission system where a mechanical power source is disposed adjacent to the length of the transmission body and the piston has an oval profile.

FIG. 9a illustrates a first example embodiment of an exoskeleton system comprising a first pneumatic transmission system fluidically coupled to a first fluidic actuator and a separate second pneumatic transmission system fluidically coupled to a second fluidic actuator.

FIG. 9b illustrates another example embodiment of an exoskeleton system that comprises a single pneumatic power transmission coupled to a first and second fluidic actuator via valving that can be configured to control fluid flow between the single pneumatic power transmission and one or both of the first and second fluidic actuators at a given time.

FIG. 10a illustrates a further example embodiment of an exoskeleton system, comprising a first and second pneumatic transmission system coupled to a single fluidic actuator via valving.

FIG. 10b illustrates yet another example embodiment of an exoskeleton system that comprises a first, second and third pneumatic transmission where the first and second pneumatic transmissions are connected exclusively and respectively to a first and second fluidic actuator.

FIG. 11a illustrates another embodiment of an exoskeleton system that comprises a first, second and third transmission system that are configured to be fluidically coupled to a first and second fluidic actuator via valving.

FIG. 11b illustrates an example embodiment where valving allows a first and second power transmission unit to be selectively plumbed to one or both of a first and second actuator.

FIG. 12a illustrates a side view of a pneumatic actuator in a compressed configuration in accordance with one embodiment.

FIG. 12b illustrates a side view of the pneumatic actuator of FIG. 12a in an expanded configuration.

FIG. 13a illustrates a cross-sectional side view of a pneumatic actuator in a compressed configuration in accordance with another embodiment.

FIG. 13b illustrates a cross-sectional side view of the pneumatic actuator of FIG. 13a in an expanded configuration.

FIG. 14a illustrates a top view of a pneumatic actuator in a compressed configuration in accordance with another embodiment.

FIG. 14b illustrates a top of the pneumatic actuator of FIG. 14a in an expanded configuration.

FIG. 15 illustrates a top view of a pneumatic actuator constraint rib in accordance with an embodiment.

FIG. 16a illustrates a cross-sectional view of a pneumatic actuator bellows in accordance with another embodiment.

FIG. 16b illustrates a side view of the pneumatic actuator of FIG. 16a in an expanded configuration showing the cross section of FIG. 16a.

FIG. 17 illustrates an example planar material that is substantially inextensible along one or more plane axes of the planar material while being flexible in other directions.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION

This application discloses example embodiments of the design of a novel pneumatic power transmission. Various examples can have application to mobile pneumatic robots due to the combination of high distal specific power that can be present in some pneumatic systems with the efficiencies that can be typical of electromechanical systems. Some pneumatic power transmissions use a pneumatic compressor as the primary power generation source where electrical power is converted to pneumatic power. Various compressor technologies however, can be rather heavy and can operate at very low overall efficiencies due to flow restrictions inherent to these designs and the use of an open pneumatic system where pressurized air is regularly exhausted into the atmosphere. This can result in some designs sacrificing run time or power capacity at the joint by downgrading the design components.

In contrast, various electromechanical systems can provide high overall efficiencies but can have relatively fixed distal mass requirements that may severely limit the speeds achievable or may increase the power burden at the actuators. The novel approach described in some examples herein can work to balance these needs in a manner suitable for mobile robotics applications. Some areas where these benefits can demonstrate value include but are not limited to devices targeting consumers, military, first responders, industrial applications, athletes, and medical devices. This specification describes the various embodiments of such a pneumatic power transmission system into functional robots.

In one aspect, the present disclosure relates to a lead-screw compressor that in some examples directly compresses and expands the air in a nominally closed system which can include a pneumatic actuator. In various embodiments, this can allow for very fast response times and high instantaneous flow rates that can achieve target pressures with high-frequency movement, which may be desirable in some applications.

One preferred embodiment includes an electromechanical mechanical power source that introduces power to a closed pneumatic system through the use of a driven piston which transmits the power through the pneumatic transmission to a custom-designed rotational pneumatic joint on the leg of a user. In such an embodiment, the main components can include the mechanical power source, the pneumatic transmission system, and the output degree of freedom such as a fluidic actuator.

The following disclosure also includes example embodiments of the design of novel exoskeleton devices. Various preferred embodiments include: a leg brace with integrated actuation, a mobile power source and a control unit that determines the output behavior of the device in real-time.

A component of an exoskeleton system that is present in various embodiments is a body-worn, lower-extremity brace that incorporates the ability to introduce torque to the user. One preferred embodiment of this component is a leg brace that is configured to support the knee of the user and includes actuation across the knee joint to provide assistance torques in the extension direction. This embodiment can connect to the user through a series of attachments including one on the boot, below the knee, and along the user's thigh. This preferred embodiment can include this type of leg brace on both legs of the user.

The present disclosure teaches example embodiments of a fluidic exoskeleton system that includes one or more adjustable fluidic actuators. Some preferred embodiments include a fluidic actuator that can be operated at various pressure levels with a large stroke length in a configuration that can be oriented with a joint on a human body.

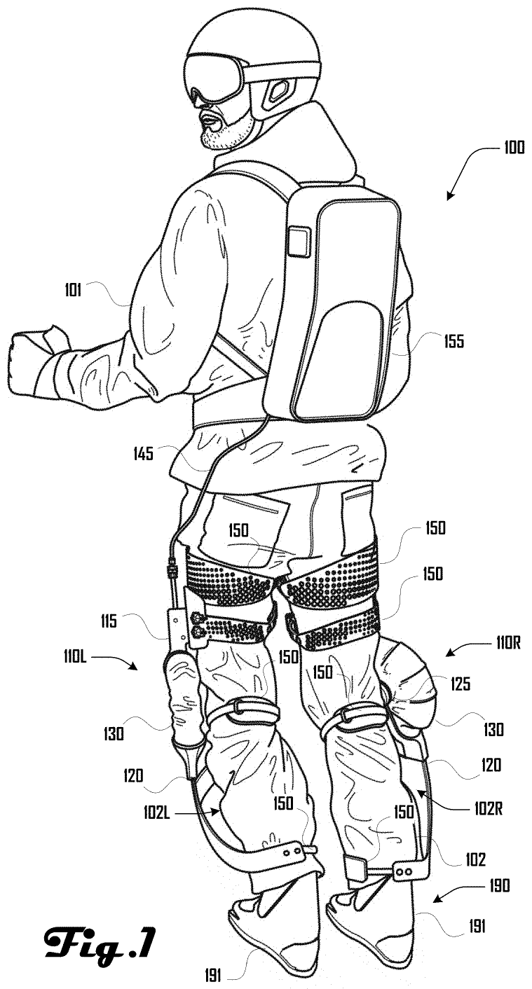

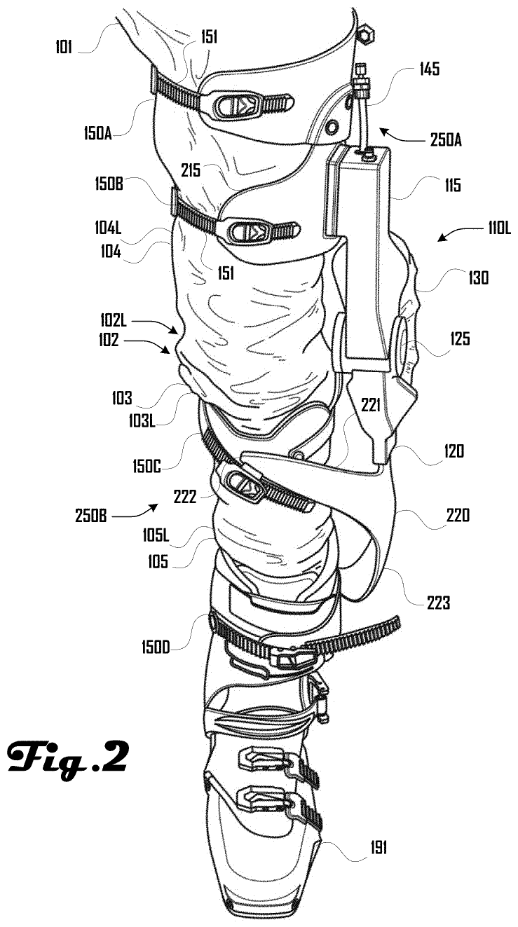

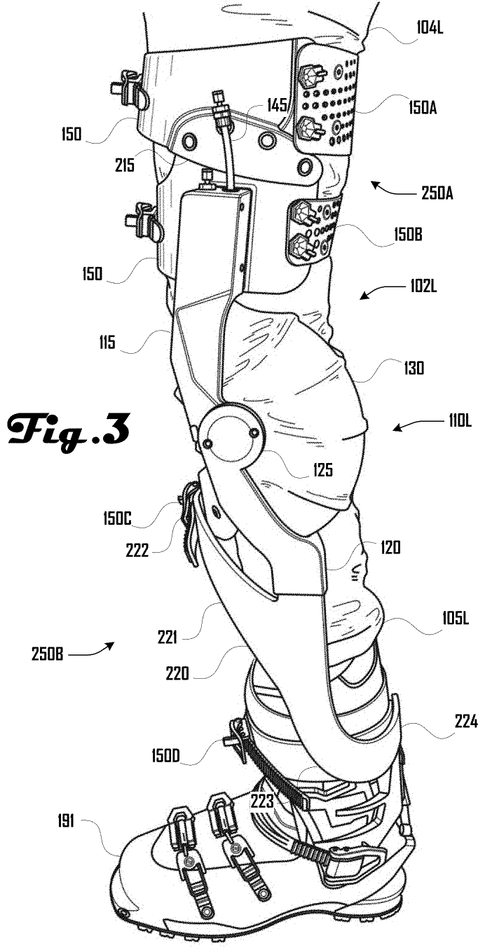

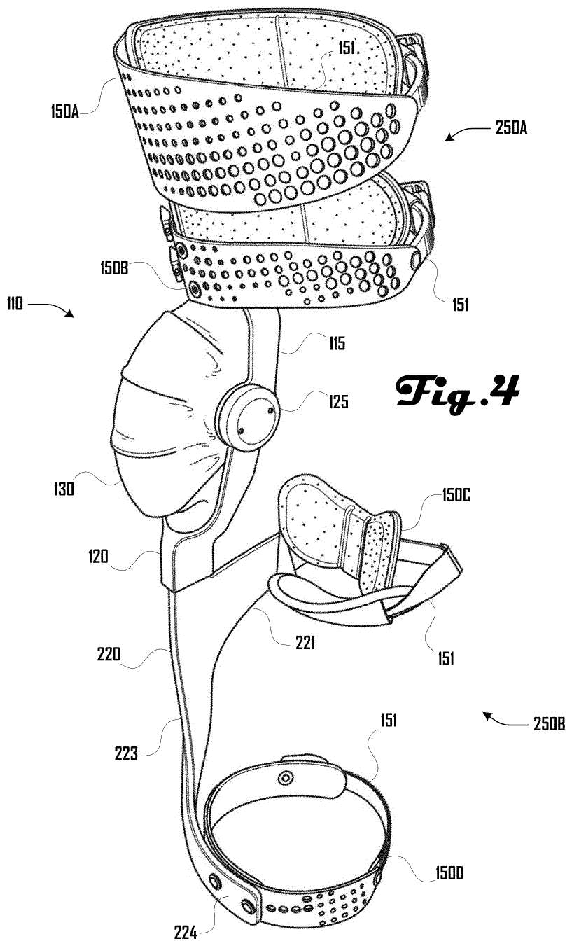

As discussed herein, an exoskeleton system 100 can be configured for various suitable uses. For example, FIGS. 1-3 illustrate an exoskeleton system 100 being used by a user. As shown in FIG. 1 the user 101 can wear the exoskeleton system 100 on both legs 102. FIGS. 2 and 3 illustrate a front and side view of an actuator unit 110 coupled to a leg 102 of a user 101 and FIG. 4 illustrates a side view of an actuator unit 110 not being worn by a user 101.

As shown in the example of FIG. 1, the exoskeleton system 100 can comprise a left and right leg actuator unit 110L, 110R that are respectively coupled to a left and right leg 102L, 102R of the user. In various embodiments, the left and right leg actuator units 110L, 110R can be substantially mirror images of each other.

As shown in FIGS. 1-4, leg actuator units 110 can include an upper arm 115 and a lower arm 120 that are rotatably coupled via a joint 125. A bellows actuator 130 extends between the upper arm 115 and lower arm 120. One or more sets of pneumatic lines 145 can be coupled to the bellows actuator 130 to introduce and/or remove fluid from the bellows actuator 130 to cause the bellows actuator 130 to expand and contract and to stiffen and soften, as discussed herein. A backpack 155 can be worn by the user 101 and can hold various components of the exoskeleton system 100 such as a fluid source, control system, a power source, and the like.

As shown in FIGS. 1-3, the leg actuator units 110L, 110R can be respectively coupled about the legs 102L, 102R of the user 101 with the joints 125 positioned at the knees 103L, 103R of the user 101 with the upper arms 115 of the leg actuator units 110L, 110R being coupled about the upper legs portions 104L, 104R of the user 101 via one or more couplers 150 (e.g., straps that surround the legs 102). The lower arms 120 of the leg actuator units 110L, 110R can be coupled about the lower leg portions 105L, 105R of the user 101 via one or more couplers 150.

The upper and lower arms 115, 120 of a leg actuator unit 110 can be coupled about the leg 102 of a user 101 in various suitable ways. For example, FIGS. 1-3 illustrates an example where the upper and lower arms 115, 120 and joint 125 of the leg actuator unit 110 are coupled along lateral faces (sides) of the top and bottom portions 104, 105 of the leg 102. As shown in the example of FIGS. 1-3, the upper arm 115 can be coupled to the upper leg portion 104 of a leg 102 above the knee 103 via two couplers 150 and the lower arm 120 can be coupled to the lower leg portion 105 of a leg 102 below the knee 103 via two couplers 150.

Specifically, upper arm 115 can be coupled to the upper leg portion 104 of the leg 102 above the knee 103 via a first set of couplers 250A that includes a first and second coupler 150A, 150B. The first and second couplers 150A, 150B can be joined by a rigid plate assembly 215 disposed on a lateral side of the upper leg portion 104 of the leg 102, with straps 151 of the first and second couplers 150A, 150B extending around the upper leg portion 104 of the leg 102. The upper arm 115 can be coupled to the plate assembly 215 on a lateral side of the upper leg portion 104 of the leg 102, which can transfer force generated by the upper arm 115 to the upper leg portion 104 of the leg 102.

The lower arm 120 can be coupled to the lower leg portion 105 of a leg 102 below the knee 103 via second set of couplers 250B that includes a third and fourth coupler 150C, 150D. A coupling branch unit 220 can extend from a distal end of, or be defined by a distal end of the lower arm 120. The coupling branch unit 220 can comprise a first branch 221 that extends from a lateral position on the lower leg portion 105 of the leg 102, curving upward and toward the anterior (front) of the lower leg portion 105 to a first attachment 222 on the anterior of the lower leg portion 105 below the knee 103, with the first attachment 222 joining the third coupler 150C and the first branch 221 of the coupling branch unit 220. The coupling branch unit 220 can comprise a second branch 223 that extends from a lateral position on the lower leg portion 105 of the leg 102, curving downward and toward the posterior (back) of the lower leg portion 105 to a second attachment 224 on the posterior of the lower leg portion 105 below the knee 103, with the second attachment 224 joining the fourth coupler 150D and the second branch 223 of the coupling branch unit 220.

As shown in the example of FIGS. 1-3, the fourth coupler 150D can be configured to surround and engage the boot 191 of a user. For example, the strap 151 of the fourth coupler 150D can be of a size that allows the fourth coupler 150D to surround the larger diameter of a boot 191 compared to the lower portion 105 of the leg 102 alone. Also, the length of the lower arm 120 and/or coupling branch unit 220 can be of a length sufficient for the fourth coupler 150D to be positioned over a boot 191 instead of being of a shorter length such that the fourth coupler 150D would surround a section of the lower portion 105 of the leg 102 above the boot 191 when the leg actuator unit 110 is worn by a user.

Attaching to the boot 191 can vary across various embodiments. In one embodiment, this attachment can be accomplished through a flexible strap that wraps around the circumference of boot 191 to affix the leg actuator unit 110 to the boot 191 with the desired amount of relative motion between the leg actuator unit 110 and the strap. Other embodiments can work to restrict various degrees of freedom while allowing the desired amount of relative motion between the leg actuator unit 110 and the boot 191 in other degrees of freedom. One such embodiment can include the use of a mechanical clip that connects to the back of the boot 191 that can provide a specific mechanical connection between the device and the boot 191. Various embodiments can include but are not limited to the designs listed previously, a mechanical bolted connection, a rigid strap, a magnetic connection, an electro-magnetic connection, an electromechanical connection, an insert into the user's boot, a rigid or flexible cable, or a connection directly to a 192.

Another aspect of the exoskeleton system 100 can be fit components used to secure the exoskeleton system 100 to the user 101. Since the function of the exoskeleton system 100 in various embodiments can rely heavily on the fit of the exoskeleton system 100 efficiently transmitting forces between the user 101 and the exoskeleton system 100 without the exoskeleton system 100 significantly drifting on the body 101 or creating discomfort, improving the fit of the exoskeleton system 100 and monitoring the fit of the exoskeleton system 100 to the user over time can be desirable for the overall function of the exoskeleton system 100 in some embodiments.

In various examples, different couplers 150 can be configured for different purposes, with some couplers 150 being primarily for the transmission of forces, with others being configured for secure attachment of the exoskeleton system 100 to the body 101. In one preferred embodiment for a single knee system, a coupler 150 that sits on the lower leg 105 of the user 101 (e.g., one or both of couplers 150C, 150D) can be intended to target body fit, and as a result, can remain flexible and compliant to conform to the body of the user 101. Alternatively, in this embodiment a coupler 150 that affixes to the front of the user's thigh on an upper portion 104 of the leg 102 (e.g., one or both of couplers 150A, 150B) can be intended to target power transmission needs and can have a stiffer attachment to the body than other couplers 150 (e.g., one or both of couplers 150C, 150D). Various embodiments can employ a variety of strapping or coupling configurations, and these embodiments can extend to include any variety of suitable straps, couplings, or the like, where two parallel sets of coupling configurations are meant to fill these different needs.

In some cases the design of the joint 125 can improve the fit of the exoskeleton system 100 on the user. In one embodiment, the joint 125 of a single knee leg actuator unit 110 can be designed to use a single pivot joint that has some deviations with the physiology of the knee joint. Another embodiment, uses a polycentric knee joint to better fit the motion of the human knee joint, which in some examples can be desirably paired with a very well fit leg actuator unit 110. Various embodiments of a joint 125 can include but are not limited to the example elements listed above, a ball and socket joint, a four bar linkage, and the like.

Some embodiments can include fit adjustments for anatomical variations in varus or valgus angles in the lower leg 105. One preferred embodiment includes an adjustment incorporated into a leg actuator unit 110 in the form of a cross strap that spans the joint of the knee 103 of the user 101, which can be tightened to provide a moment across the knee joint in the frontal plane which varies the nominal resting angle. Various embodiments can include but are not limited to the following: a strap that spans the joint 125 to vary the operating angle of the joint 125; a mechanical assembly including a screw that can be adjusted to vary the angle of the joint 125; mechanical inserts that can be added to the leg actuator unit 110 to discreetly change the default angle of the joint 125 for the user 101, and the like.

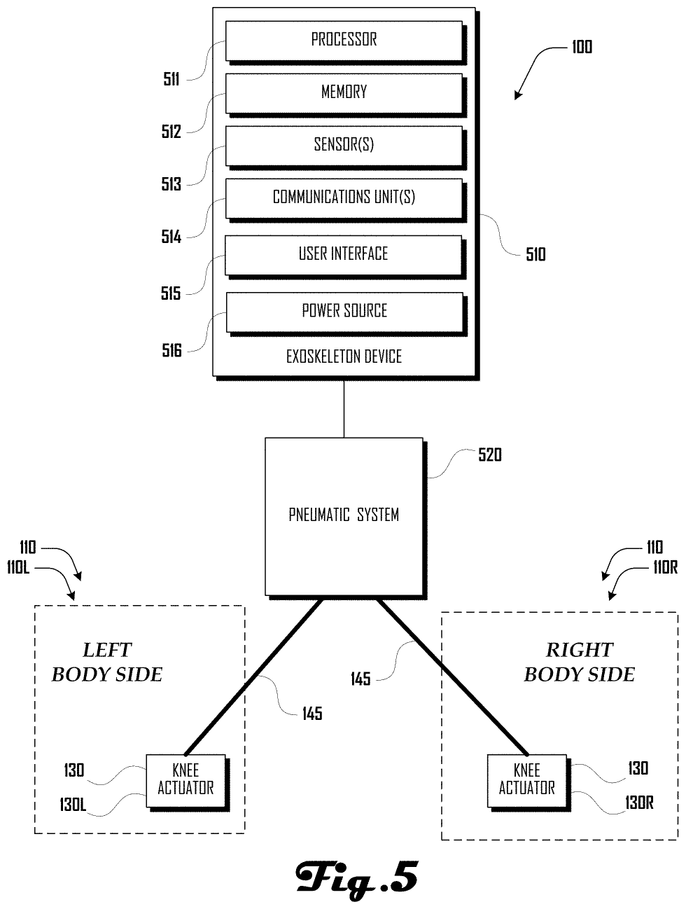

In various embodiments, the leg actuator unit 110 can be configured to remain suspended vertically on the leg 102 and remain appropriately positioned with the joint of the knee 103. In one embodiment, coupler 150 associated with a boot 191 (e.g., coupler 150D) can provide a vertical retention force for a leg actuator unit 110. Another embodiment uses a coupler 150 positioned on the lower leg 105 of the user 101 (e.g., one or both of couplers 150C, 150D) that exerts a vertical force on the leg actuator unit 110 by reacting on the calf of the user 101. Various embodiments can include but are not limited to the following: suspension forces transmitted through a coupler 150 on the boot (e.g., coupler 150D) or another embodiment of the boot attachment discussed previously; suspension forces transmitted through an electronic and/or fluidic cable assembly; suspension forces transmitted through a connection to a waist belt; suspension forces transmitted through a mechanical connection to a backpack 155 or other housing for the exoskeleton device 510 and/or pneumatic system 520 (see FIG. 5); suspension forces transmitted through straps or a harness to the shoulders of the user 101, and the like.

In various embodiments, a leg actuator unit 110 can be spaced apart from the leg 102 of the user with a limited number of attachments to the leg 102. For example, in some embodiments, the leg actuator unit 110 can consist or consist essentially of three attachments to the leg 102 of the user 101, namely via the first and second attachments 222, 224 and 215. In various embodiments, the couplings of the leg actuator unit 110 to the lower leg portion 105 can consist or consist essentially of a first and second attachment on the anterior and posterior of the lower leg portion 105. In various embodiments, the coupling of the leg actuator unit 110 to the upper leg portion 104 can consist or consist essentially of a single lateral coupling, which can be associated with one or more couplers 150 (e.g., two couplers 150A, 150B as shown in FIGS. 1-4). In various embodiments, such a configuration can be desirable based on the specific force-transfer for use during a subject activity. Accordingly, the number and positions of attachments or coupling to the leg 102 of the user 101 in various embodiments is not a simple design choice and can be specifically selected for one or more selected target user activities.

While specific embodiments of couplers 150 are illustrated herein, in further embodiments, such components discussed herein can be operably replaced by an alternative structure to produce the same functionality. For example, while straps, buckles, padding and the like are shown in various examples, further embodiments can include couplers 150 of various suitable types and with various suitable elements. For example, some embodiments can include Velcro hook-and-loop straps, or the like.

FIGS. 1-3 illustrate an example of an exoskeleton system 100 where the joint 125 is disposed laterally and adjacent to the knee 103 with a rotational axis of the joint 125 being disposed parallel to a rotational axis of the knee 103. In some embodiments, the rotational axis of the joint 125 can be coincident with the rotational axis of the knee 103. In some embodiments, a joint can be disposed on the anterior of the knee 103, posterior of the knee 103, inside of the knee 103, or the like.

In various embodiments, the joint structure 125 can constrain the bellows actuator 130 such that force created by actuator fluid pressure within the bellows actuator 130 can be directed about an instantaneous center (which may or may not be fixed in space). In some cases of a revolute or rotary joint, or a body sliding on a curved surface, this instantaneous center can coincide with the instantaneous center of rotation of the joint 125 or a curved surface. Forces created by a leg actuator unit 110 about a rotary joint 125 can be used to apply a moment about an instantaneous center as well as still be used to apply a directed force. In some cases of a prismatic or linear joint (e.g., a slide on a rail, or the like), the instantaneous center can be kinematically considered to be located at infinity, in which case the force directed about this infinite instantaneous center can be considered as a force directed along the axis of motion of the prismatic joint. In various embodiments, it can be sufficient for a rotary joint 125 to be constructed from a mechanical pivot mechanism. In such an embodiment, the joint 125 can have a fixed center of rotation that can be easy to define, and the bellows actuator 130 can move relative to the joint 125. In a further embodiment, it can be beneficial for the joint 125 to comprise a complex linkage that does not have a single fixed center of rotation. In yet another embodiment, the joint 125 can comprise a flexure design that does not have a fixed joint pivot. In still further embodiments, the joint 125 can comprise a structure, such as a human joint, robotic joint, or the like.

In various embodiments, leg actuator unit 110 (e.g., comprising bellows actuator 130, joint structure 125, and the like) can be integrated into a system to use the generated directed force of the leg actuator unit 110 to accomplish various tasks. In some examples, a leg actuator unit 110 can have one or more unique benefits when the leg actuator unit 110 is configured to assist the human body or is included into a powered exoskeleton system 100. In an example embodiment, the leg actuator unit 110 can be configured to assist the motion of a human user about the user's knee joint 103. To do so, in some examples, the instantaneous center of the leg actuator unit 110 can be designed to coincide or nearly coincide with the instantaneous center of rotation of the knee 103 of a user 101. In one example configuration, the leg actuator unit 110 can be positioned lateral to the knee joint 103 as shown in FIGS. 1-3. In various examples, the human knee joint 103 can function as (e.g., in addition to or in place of) the joint 125 of the leg actuator unit 110.

For clarity, example embodiments discussed herein should not be viewed as a limitation of the potential applications of the leg actuator unit 110 described within this disclosure. The leg actuator unit 110 can be used on other joints of the body including but not limited to one or more elbow, one or more hip, one or more finger, one or more ankle, spine, or neck. In some embodiments, the leg actuator unit 110 can be used in applications that are not on the human body such as in robotics, for general purpose actuation, animal exoskeletons, or the like.

Also, embodiments can be used for or adapted for various suitable applications such as tactical, medical, or labor applications, and the like. Examples of such applications can be found in U.S. patent application Ser. No. 15/823,523, filed Nov. 27, 2017 entitled “PNEUMATIC EXOMUSCLE SYSTEM AND METHOD” with attorney docket number 0110496-002US1 and U.S. patent application Ser. No. 15/953,296, filed Apr. 13, 2018 entitled “LEG EXOSKELETON SYSTEM AND METHOD” with attorney docket number 0110496-004US0, which are incorporated herein by reference.

Some embodiments can apply a configuration of a leg actuator unit 110 as described herein for linear actuation applications. In an example embodiment, the bellows actuator 130 can comprise a two-layer impermeable/inextensible construction, and one end of one or more constraining ribs can be fixed to the bellows actuator 130 at predetermined positions. The joint structure 125 in various embodiments can be configured as a series of slides on a pair of linear guide rails, where the remaining end of one or more constraining ribs is connected to a slide. The motion and force of the fluidic actuator can therefore be constrained and directed along the linear rail.

FIG. 5 is a block diagram of an example embodiment of an exoskeleton system 100 that includes an exoskeleton device 510 that is operably connected to a pneumatic system 520. While a pneumatic system 520 is used in the example of FIG. 5, further embodiments can include any suitable fluidic system or a pneumatic system 520 can be absent in some embodiments, such as where an exoskeleton system 100 is actuated by electric motors, or the like.

The exoskeleton device 510 in this example comprises a processor 511, a memory 512, one or more sensors 513 a communication unit 514, a user interface 515 and a power source 516. A plurality of actuators 130 are operably coupled to the pneumatic system 520 via respective pneumatic lines 145. The plurality of actuators 130 include a pair of knee-actuators 130Land 130R that are positioned on the right and left side of a body 100. For example, as discussed above, the example exoskeleton system 100 shown in FIG. 5 can comprise a left and right leg actuator unit 110L, 110R on respective sides of the body 101 as shown in FIGS. 1 and 2 with one or both of the exoskeleton device 510 and pneumatic system 520, or one or more components thereof, stored within or about a backpack 155 (see FIG. 1) or otherwise mounted, worn or held by a user 101.

Accordingly, in various embodiments, the exoskeleton system 100 can be a completely mobile and self-contained system that is configured to be powered and operate for an extended period of time without an external power source during various user activities. The size, weight and configuration of the actuator unit(s) 110, exoskeleton device 510 and pneumatic system 520 can therefore be configured in various embodiments for such mobile and self-contained operation.

In various embodiments, the example system 100 can be configured to move and/or enhance movement of the user 101 wearing the exoskeleton system 100. For example, the exoskeleton device 510 can provide instructions to the pneumatic system 520, which can selectively inflate and/or deflate the bellows actuators 130 via pneumatic lines 145. Such selective inflation and/or deflation of the bellows actuators 130 can move and/or support one or both legs 102 to generate and/or augment body motions such as walking, running, jumping, climbing, lifting, throwing, squatting, skiing or the like.

In some cases, the exoskeleton system 100 can be designed to support multiple configurations in a modular configuration. For example, one embodiment is a modular configuration that is designed to operate in either a single knee configuration or in a double knee configuration as a function of how many of the actuator units 110 are donned by the user 101. For example, the exoskeleton device 510 can determine how many actuator units 110 are coupled to the pneumatic system 520 and/or exoskeleton device 510 (e.g., on or two actuator units 110) and the exoskeleton device 510 can change operating capabilities based on the number of actuator units 110 detected.

In further embodiments, the pneumatic system 520 can be manually controlled, configured to apply a constant pressure, or operated in any other suitable manner. In some embodiments, such movements can be controlled and/or programmed by the user 101 that is wearing the exoskeleton system 100 or by another person. In some embodiments, the exoskeleton system 100 can be controlled by movement of the user 101. For example, the exoskeleton device 510 can sense that the user is walking and carrying a load and can provide a powered assist to the user via the actuators 130 to reduce the exertion associated with the load and walking. Similarly, where a user 101 wears the exoskeleton system 100, the exoskeleton system 100 can sense movements of the user 101 and can provide a powered assist to the user via the actuators 130 to enhance or provide an assist to the user while skiing.

Accordingly, in various embodiments, the exoskeleton system 130 can react automatically without direct user interaction. In further embodiments, movements can be controlled in real-time by user interface 515 such as a controller, joystick, voice control or thought control. Additionally, some movements can be pre-preprogrammed and selectively triggered (e.g., walk forward, sit, crouch) instead of being completely controlled. In some embodiments, movements can be controlled by generalized instructions (e.g. walk from point A to point B, pick up box from shelf A and move to shelf B).

The user interface 515 can allow the user 101 to control various aspects of the exoskeleton system 100 including powering the exoskeleton system 100 on and off; controlling movements of the exoskeleton system 100; configuring settings of the exoskeleton system 100, and the like. The user interface 515 can include various suitable input elements such as a touch screen, one or more buttons, audio input, and the like. The user interface 515 can be located in various suitable locations about the exoskeleton system 100. For example, in one embodiment, the user interface 515 can be disposed on a strap of a backpack 155, or the like. In some embodiments, the user interface can be defined by a user device such as smartphone, smart-watch, wearable device, or the like.

In various embodiments, the power source 516 can be a mobile power source that provides the operational power for the exoskeleton system 100. In one preferred embodiment, the power pack unit contains some or all of the pneumatic system 520 (e.g., a compressor) and/or power source (e.g., batteries) required for the continued operation of pneumatic actuation of the leg actuator units 110. The contents of such a power pack unit can be correlated to the specific actuation approach configured to be used in the specific embodiment. In some embodiments, the power pack unit will only contain batteries which can be the case in an electromechanically actuated system or a system where the pneumatic system 520 and power source 516 are separate. Various embodiments of a power pack unit can include but are not limited to a combination of the one or more of the following items: pneumatic compressor, batteries, stored high-pressure pneumatic chamber, hydraulic pump, pneumatic safety components, electric motor, electric motor drivers, microprocessor, and the like. Accordingly, various embodiments of a power pack unit can include one or more of elements of the exoskeleton device 510 and/or pneumatic system 520.

Such components can be configured on the body of a user 101 in a variety of suitable ways. One preferred embodiment is the inclusion of a power pack unit in a torso-worn pack that is not operably coupled to the leg actuator units 110 in any manner that transmits substantial mechanical forces to the leg actuator units 110. Another embodiment includes the integration of the power pack unit, or components thereof, into the leg actuator units 110 themselves. Various embodiments can include but are not limited to the following configurations: torso-mounted in a backpack, torso-mounted in a messenger bag, hip-mounted bag, mounted to the leg, integrated into the brace component, and the like. Further embodiments can separate the components of the power pack unit and disperse them into various configurations on the user 101. Such an embodiment may configure a pneumatic compressor on the torso of the user 101 and then integrate the batteries into the leg actuator units 110 of the exoskeleton system 100.

One aspect of the power supply 516 in various embodiments is that it must be connected to the brace component in such a manner as to pass the operable system power to the brace for operation. One preferred embodiment is the use of electrical cables to connect the power supply 516 and the leg actuator units 110. Other embodiments can use electrical cables and a pneumatic line 145 to deliver electrical power and pneumatic power to the leg actuator units 110. Various embodiments can include but are not limited to any configuration of the following connections: pneumatic hosing, hydraulic hosing, electrical cables, wireless communication, wireless power transfer, and the like.

In some embodiments, it can be desirable to include secondary features that extend the capabilities of a cable connection (e.g., pneumatic lines 145 and/or power lines) between the leg actuator units 110 and the power supply 516 and/or pneumatic system 520. One preferred embodiment includes retractable cables that are configured to have a small mechanical retention force to maintain cables that are pulled tight against the user with reduced slack remaining in the cable. Various embodiments can include, but are not limited to a combination of the following secondary features: retractable cables, a single cable including both fluidic and electrical power, magnetically-connected electrical cables, mechanical quick releases, breakaway connections designed to release at a specified pull force, integration into mechanical retention features on the user's clothing, and the like. Yet another embodiment can include routing the cables in such a way as to minimize geometric differences between the user 101 and the cable lengths. One such embodiment in a dual knee configuration with a torso power supply can be routing the cables along the user's lower torso to connect the right side of a power supply bag with the left knee of the user. Such a routing can allow the geometric differences in length throughout the user's normal range of motion.

One specific additional feature that can be a concern in some embodiments is the need for proper heat management of the exoskeleton system 100. As a result, there are a variety of features that can be integrated specifically for the benefit of controlling heat. One preferred embodiment integrates exposed heat sinks to the environment that allow elements of the exoskeleton device 510 and/or pneumatic system 520 to dispel heat directly to the environment through unforced cooling using ambient airflow. Another embodiment directs the ambient air through internal air channels in a backpack 155 or other housing to allow for internal cooling. Yet another embodiment can extend upon this capability by introducing scoops on a backpack 155 or other housing in an effort to allow air flow through the internal channels. Various embodiments can include but are not limited to the following: exposed heat sinks that are directly connected to a high heat component; a water-cooled or fluid-cooled heat management system; forced air cooling through the introduction of a powered fan or blower; external shielded heat sinks to protect them from direct contact by a user, and the like.

In some cases, it may be beneficial to integrate additional features into the structure of the backpack 155 or other housing to provide additional features to the exoskeleton system 100. One preferred embodiment is the integration of mechanical attachments to support storage of the leg actuator units 110 along with the exoskeleton device 510 and/or pneumatic system 520 in a small package. Such an embodiment can include a deployable pouch that can secure the leg actuator units 110 against the backpack 155 along with mechanical clasps that hold the upper or lower arms 115, 120 of the actuator units 110 to the backpack 155. Another embodiment is the inclusion of storage capacity into the backpack 155 so the user 101 can hold additional items such as a water bottle, food, personal electronics, and other personal items. Various embodiments can include but are not limited to other additional features such as the following: a warming pocket which is heated by hot airflow from the exoskeleton device 510 and/or pneumatic system 520; air scoops to encourage additional airflow internal to the backpack 155; strapping to provide a closer fit of the backpack 155 on the user, waterproof storage, temperature-regulated storage, and the like.

In a modular configuration, it may be required in some embodiments that the exoskeleton device 510 and/or pneumatic system 520 can be configured to support the power, fluidic, sensing and control requirements and capabilities of various potential configurations of the exoskeleton system. One preferred embodiment can include an exoskeleton device 510 and/or pneumatic system 520 that can be tasked with powering a dual knee configuration or a single knee configuration (i.e., with one or two leg actuator units 110 on the user 101). Such an exoskeleton system 100 can support the requirements of both configurations and then appropriately configure power, fluidic, sensing and control based on a determination or indication of a desired operating configuration. Various embodiments exist to support an array of potential modular system configurations, such as multiple batteries, and the like.

In various embodiments, the exoskeleton device 100 can be operable to perform methods or portions of methods described in more detail below or in related applications incorporated herein by reference. For example, the memory 512 can include non-transitory computer readable instructions (e.g., software), which if executed by the processor 511, can cause the exoskeleton system 100 to perform methods or portions of methods described herein or in related applications incorporated herein by reference.

This software can embody various methods that interpret signals from the sensors 513 or other sources to determine how to best operate the exoskeleton system 100 to provide the desired benefit to the user. The specific embodiments described below should not be used to imply a limit on the sensors 513 that can be applied to such an exoskeleton system 100 or the source of sensor data. While some example embodiments can require specific information to guide decisions, it does not create an explicit set of sensors 513 that an exoskeleton system 100 will require and further embodiments can include various suitable sets of sensors 513. Additionally, sensors 513 can be located at various suitable locations on an exoskeleton system 100 including as part of an exoskeleton device 510, pneumatic system 520, one or more fluidic actuator 130, or the like. Accordingly, the example illustration of FIG. 5 should not be construed to imply that sensors 513 are exclusively disposed at or part of an exoskeleton device 510 and such an illustration is merely provided for purposes of simplicity and clarity.

One aspect of control software can be the operational control of leg actuator units 110, exoskeleton device 510 and pneumatic system 520 to provide the desired response. There can be various suitable responsibilities of the operational control software. For example, as discussed in more detail below, one can be low-level control which can be responsible for developing baseline feedback for operation of the leg actuator units 110, exoskeleton device 510 and pneumatic system 520. Another can be intent recognition which can be responsible for identifying the intended maneuvers of the user 101 based on data from the sensors 513 and causing the exoskeleton system 100 to operate based on one or more identified intended maneuvers. A further example can include reference generation, which can include selecting the desired torques the exoskeleton system 100 should generate to best assist the user 101. It should be noted that this example architecture for delineating the responsibilities of the operational control software is merely for descriptive purposes and in no way limits the wide variety of software approaches that can be deployed on further embodiments of an exoskeleton system 100.

One method implemented by control software can be for the low-level control and communication of the exoskeleton system 100. This can be accomplished via a variety of methods as required by the specific joint and need of the user. In a preferred embodiment, the operational control is configured to provide a desired torque by the leg actuator unit 110 at the user's joint. In such a case, the exoskeleton system 100 can create low-level feedback to achieve a desired joint torque by the leg actuator units 110 as a function of feedback from the sensors 513 of the exoskeleton system 100. For example, such a method can include obtaining sensor data from one or more sensors 513, determining whether a change in torque by the leg actuator unit 110 is necessary, and if so, causing the pneumatic system 520 to change the fluid state of the leg actuator unit 110 to achieve a target joint torque by the leg actuator unit 110. Various embodiments can include, but are not limited to, the following: current feedback; recorded behavior playback; position-based feedback; velocity-based feedback; feedforward responses; volume feedback which controls a fluidic system 520 to inject a desired volume of fluid into an actuator 130, and the like.

Another method implemented by operational control software can be for intent recognition of the user's intended behaviors. This portion of the operational control software, in some embodiments, can indicate any array of allowable behaviors that the system 100 is configured to account for. In one preferred embodiment, the operational control software is configured to identify two specific states: Walking, and Not Walking. In such an embodiment, to complete intent recognition, the exoskeleton system 100 can use user input and/or sensor readings to identify when it is safe, desirable or appropriate to provide assistive actions for walking. For example, in some embodiments, intent recognition can be based on input received via the user interface 515, which can include an input for Walking, and Not Walking. Accordingly, in some examples, the use interface can be configured for a binary input consisting of Walking, and Not Walking.

In some embodiments, a method of intent recognition can include the exoskeleton device 510 obtaining data from the sensors 513 and determining, based at least in part of the obtained data, whether the data corresponds to a user state of Walking, and Not Walking. Where a change in state has been identified, the exoskeleton system 100 can be re-configured to operate in the current state. For example, the exoskeleton device 510 can determine that the user 101 is in a Not Walking state such as sitting and can configure the exoskeleton system 100 to operate in a Not Walking configuration. For example, such a Not Walking configuration can, compared to a Walking configuration, provide for a wider range of motion; provide no torque or minimal torque to the leg actuation units 110; save power and fluid by minimizing processing and fluidic operations; cause the system to be alert for supporting a wider variety of non-skiing motion, and the like.

The exoskeleton device 510 can monitor the activity of the user 101 and can determine that the user is walking or is about to walk (e.g., based on sensor data and/or user input), and can then configure the exoskeleton system 100 to operate in a Walking configuration. For example, such a Walking configuration, compared to a Not Walking configuration, can allow for a more limited range of motion that would be present during skiing (as opposed to motions during non-walking); provide for high or maximum performance by increasing the processing and fluidic response of the exoskeleton system 100 to support skiing; and the like. When the user 101 finishes a walking session, is identified as resting, or the like, the exoskeleton system 100 can determine that the user is no longer walking (e.g., based on sensor data and/or user input) and can then configure the exoskeleton system 100 to operate in the Not Walking configuration.

In some embodiments, there can be a plurality of Walking states, or Walking sub-states that can be determined by the exoskeleton system 100, including hard walking, moderate walking, light walking, downhill, uphill, jumping, recreational, sport, running, and the like (e.g., based on sensor data and/or user input). Such states can be based on the difficulty of the walking, ability of the user, terrain, weather conditions, elevation, angle of the walking surface, desired performance level, power-saving, and the like. Accordingly, in various embodiments, the exoskeleton system 100 can adapt for various specific types of walking or movement based on a wide variety of factors.

Another method implemented by operational control software can be the development of desired referenced behaviors for the specific joints providing assistance. This portion of the control software can tie together identified maneuvers with the level control. For example, when the exoskeleton system 100 identifies an intended user maneuver, the software can generate reference behaviors that define the torques, or positions desired by the actuators 130 in the leg actuation units 110. In one embodiment, the operational control software generates references to make the leg actuation units 110 simulate a mechanical spring at the knee 103 via the configuration actuator 130. The operational control software can generate torque references at the knee joints that are a linear function of the knee joint angle. In another embodiment, the operational control software generates a volume reference to provide a constant standard volume of air into a pneumatic actuator 130. This can allow the pneumatic actuator 130 to operate like a mechanical spring by maintaining the constant volume of air in the actuator 130 regardless of the knee angle, which can be identified through feedback from one or more sensors 513.

In another embodiment, a method implemented by the operational control software can include evaluating the balance of the user 101 while walking, moving, standing, or running and directing torque in such a way to encourage the user 101 to remain balanced by directing knee assistance to the leg 102 that is on the outside of the user's current balance profile. Accordingly, a method of operating an exoskeleton system 100 can include the exoskeleton device 510 obtaining sensor data from the sensors 510 indicating a balance profile of a user 101 based on the configuration of left and right leg actuation units 110L, 110R and/or environmental sensors such as position sensors, accelerometers, and the like. The method can further include determining a balance profile based on the obtained data, including an outside and inside leg, and then increasing torque to the actuation unit 110 associated with the leg 102 identified as the outside leg.

Various embodiments can use but are not limited to kinematic estimates of posture, joint kinetic profile estimates, as well as observed estimates of body pose. Various other embodiments exist for methods of coordinating two legs 102 to generate torques including but not limited to guiding torque to the most bent leg; guiding torque based on the mean amount of knee angle across both legs; scaling the torque as a function of speed or acceleration; and the like. It should also be noted that yet another embodiment can include a combination of various individual reference generation methods in a variety of matters which include but are not limited to a linear combination, a maneuver specific combination, or a non-linear combination.

In another embodiment, an operational control method can blend two primary reference generation techniques: one reference focused on static assistance and one reference focused on leading the user 101 into their upcoming behavior. In some examples, the user 101 can select how much predictive assistance is desired while using the exoskeleton system 100. For example, by a user 101 indicating a large amount of predictive assistance, the exoskeleton system 100 can be configured to be very responsive and may be well configured for a skilled operator on a challenging terrain. The user 101 could also indicate a desire for a very low amount of predictive assistance, which can result in slower system performance, which may be better tailored towards a learning user or less challenging terrain.

Various embodiments can incorporate user intent in a variety of manners and the example embodiments presented above should not be interpreted as limiting in any way. For example, method of determining and operating an exoskeleton system 100 can include systems and method of U.S. patent application Ser. No. 15/887,866, filed Feb. 2, 2018 entitled “SYSTEM AND METHOD FOR USER INTENT RECOGNITION,” having attorney docket number 0110496-003US0, which is incorporated herein by reference. Also, various embodiments can use user intent in a variety of manners including as a continuous unit, or as a discrete setting with only a few indicated values.

At times it can be beneficial for operational control software to manipulate its control to account for a secondary or additional objective in order to maximize device performance or user experience. In one embodiment, the exoskeleton system 100 can provide an elevation-aware control over a central compressor or other components of a pneumatic system 520 to account for the changing density of air at different elevations. For example, operational control software can identify that the system is operating at a higher elevation based on data from sensors 513, or the like, and provide more current to the compressor in order to maintain electrical power consumed by the compressor. Accordingly, a method of operating a pneumatic exoskeleton system 100 can include obtaining data indicating air density where the pneumatic exoskeleton system 100 is operating (e.g., elevation data), determining optimal operating parameters of the pneumatic system 520 based on the obtained data, and configuring operation based on the determined optimal operating parameters. In further embodiments, operation of a pneumatic exoskeleton system 100 such as operating volumes can be tuned based on environmental temperature, which may affect air volumes.

In another embodiment, the exoskeleton system 100 can monitor the ambient audible noise levels and vary the control behavior of the exoskeleton system 100 to reduce the noise profile of the system. For example, when a user 101 is in a quiet public place or quietly enjoying a location alone or with others, noise associated with actuation of the leg actuation units 110 can be undesirable (e.g., noise of running a compressor or inflating or deflating actuators 130). Accordingly, in some embodiments, the sensors 513 can include a microphone that detects ambient noise levels and can configure the exoskeleton system 100 to operate in a quiet mode when ambient noise volume is below a certain threshold. Such a quiet mode can configure elements of a pneumatic system 520 or actuators 130 to operate more quietly, or can delay or reduce frequency of noise made by such elements.

In the case of a modular system, it can be desirable in various embodiments for operational control software to operate differently based on the number of leg actuation units 110 operational within the exoskeleton system 100. For example, in some embodiments, a modular dual-knee exoskeleton system 100 (see e.g., FIGS. 1 and 2) can also operate in a single knee configuration where only one of two leg actuation units 110 are being worn by a user 101 (see e.g., FIGS. 3 and 4) and the exoskeleton system 100 can generate references differently when in a two-leg configuration compared to a single leg configuration. Such an embodiment can use a coordinated control approach to generate references where the exoskeleton system 100 is using inputs from both leg actuation units 110 to determine the desired operation. However in a single-leg configuration, the available sensor information may have changed, so in various embodiments the exoskeleton system 100 can implement a different control method. In various embodiments this can be done to maximize the performance of the exoskeleton system 100 for the given configuration or account for differences in available sensor information based on there being one or two leg actuation units 110 operating in the exoskeleton system 100.

Accordingly, a method of operating an exoskeleton system 100 can include a startup sequence where a determination is made by the exoskeleton device 510 whether one or two leg actuation units 110 are operating in the exoskeleton system 100; determining a control method based on the number of actuation units 110 that are operating in the exoskeleton system 100; and implementing and operating the exoskeleton system 100 with the selected control method. A further method operating an exoskeleton system 100 can include monitoring by the exoskeleton device 510 of actuation units 110 that are operating in the exoskeleton system 100, determining a change in the number of actuation units 110 operating in the exoskeleton system 100, and then determining and changing the control method based on the new number of actuation units 110 that are operating in the exoskeleton system 100.

For example, the exoskeleton system 100 can be operating with two actuation units 110 and with a first control method. The user 101 can disengage one of the actuation units 110, and the exoskeleton device 510 can identify the loss of one of the actuation units 110 and the exoskeleton device 510 can determine and implement a new second control method to accommodate loss of one of the actuation units 110. In some examples, adapting to the number of active actuation units 110 can be beneficial where one of the actuation units 110 is damaged or disconnected during use and the exoskeleton system 100 is able to adapt automatically so the user 101 can still continue working or moving uninterrupted despite the exoskeleton system 100 only having a single active actuation unit 110.

In various embodiments, operational control software can adapt a control method where user needs are different between individual actuation units 110 or legs 102. In such an embodiment, it can be beneficial for the exoskeleton system 100 to change the torque references generated in each actuation unit 110 to tailor the experience for the user 101. One example is of a dual knee exoskeleton system 100 (see e.g., FIG. 1) where a user 101 has significant weakness issues in a single leg 102, but only minor weakness issues in the other leg 102. In this example, the exoskeleton system 100 can be configured to scale down the output torques on the less-affected limb compared to the more-affected limb to best meet the needs of the user 101.

Such a configuration based on differential limb strength can be done automatically by the exoskeleton system 100 and/or can be configured via a user interface 516, or the like. For example, in some embodiments, the user 101 can perform a calibration test while using the exoskeleton system 100, which can test relative strength or weakness in the legs 102 of the user 101 and configure the exoskeleton system 100 based on identified strength or weakness in the legs 102. Such a test can identify general strength or weakness of legs 102 or can identify strength or weakness of specific muscles or muscle groups such as the quadriceps, calves, hamstrings, gluteus, gastrocnemius; femoris, sartorius, soleus, and the like.

Another aspect of a method for operating an exoskeleton system 100 can include control software that monitors the exoskeleton system 100. A monitoring aspect of such software can, in some examples, focus on monitoring the state of the exoskeleton system 100 and the user 101 throughout normal operation in an effort to provide the exoskeleton system 100 with situational awareness and understanding of sensor information in order to drive user understanding and device performance. One aspect of such monitoring software can be to monitor the state of the exoskeleton system 100 in order to provide device understanding to achieve a desired performance capability. A portion of this can be the development of a system body pose estimate. In one embodiment, the exoskeleton device 510 uses the onboard sensors 513 to develop a real-time understanding of the user's pose. In other words, data from sensors 513 can be used to determine the configuration of the actuation units 110, which along with other sensor data can in turn be used to infer a user pose or body configuration estimate of the user 101 wearing the actuation units 110.

At times, and in some embodiments, it can be unrealistic or impossible for the exoskeleton system 100 to directly sense all important aspects of the system pose due to the sensing modalities not existing or their inability to be practically integrated into the hardware. As a result, the exoskeleton system 100 in some examples can rely on a fused understanding of the sensor information around an underlying model of the user's body and the exoskeleton system 100 the user is wearing. In one embodiment of a dual leg knee assistance exoskeleton system 100, the exoskeleton device 510 can use an underlying model of the user's lower extremity and torso body segments to enforce a relational constraint between the otherwise disconnected sensors 513. Such a model can allow the exoskeleton system 100 to understand the constrained motion of the two legs 102 in that they are mechanically connected through the user's kinematic chain created by the body. This approach can be used to ensure that the estimates for knee orientation are properly constrained and biomechanically valid. In various embodiments, the exoskeleton system 100 can include sensors 513 embedded in the exoskeleton device 510 and/or pneumatic system 520 to provide a fuller picture of the system posture. In yet another embodiment, the exoskeleton system 100 can include logical constraints that are unique to the application in an effort to provide additional constraints on the operation of the pose estimation. This can be desirable, in some embodiments, in conditions where ground truth information is unavailable such as highly dynamic actions, where the exoskeleton system 100 is denied an external GPS signal, or the earth's magnetic field is distorted.

In some embodiments, changes in configuration of the exoskeleton system 100 based location and/or location attributes can be performed automatically and/or with input from the user 101. For example, in some embodiments, the exoskeleton system 100 can provide one or more suggestions for a change in configuration based on location and/or location attributes and the user 101 can choose to accept such suggestions. In further embodiments, some or all configurations of the exoskeleton system 100 based location and/or location attributes can occur automatically without user interaction.

Various embodiments can include the collection and storage of data from the exoskeleton system 100 throughout operation. In one embodiment, this can include the live streaming of the data collected on the exoskeleton device 510 to a cloud storage location via the communication unit(s) 514 through an available wireless communication protocol or storage of such data on the memory 512 of the exoskeleton device 510, which may then be uploaded to another location via the communication unit(s) 514. For example, when the exoskeleton system 100 obtains a network connection, recorded data can be uploaded to the cloud at a communication rate that is supported by the available data connection. Various embodiments can include variations of this, but the use of monitoring software to collect and store data about the exoskeleton system 100 locally and/or remotely for retrieval at a later time for an exoskeleton system 100 such as this can be included in various embodiments.

In some embodiments, once such data has been recorded, it can be desirable to use the data for a variety of different applications. One such application can be the use of the data to develop further oversight functions on the exoskeleton system 100 in an effort to identify device system issues that are of note. One embodiment can be the use of the data to identify a specific exoskeleton system 100 or leg actuator unit 110 among a plurality, whose performance has varied significantly over a variety of uses. Another use of the data can be to provide it back to the user 101 to gain a better understanding of how they ski. One embodiment of this can be providing the data back to the user 101 through a mobile application that can allow the user 101 to review their use on a mobile device. Yet another use of such device data can be to synchronize playback of data with an external data stream to provide additional context. One embodiment is a system that incorporates the GPS data from a companion smartphone with the data stored natively on the device. Another embodiment can include the time synchronization of recorded video with the data stored that was obtained from the device 100. Various embodiments can use these methods for immediate use of data by the user to evaluate their own performance, for later retrieval by the user to understand behavior from the past, for users to compare with other users in-person or through an online profile, by developers to further the development of the system, and the like.

Another aspect of a method of operating an exoskeleton system 100 can include monitoring software configured for identifying user-specific traits. For example, the exoskeleton system 100 can provide an awareness of how a specific skier 101 operates in the exoskeleton system 100 and over time can develop a profile of the user's specific traits in an effort to maximize device performance for that user. One embodiment can include the exoskeleton system 100 identifying a user-specific use type in an effort to identify the use style or skill level of the specific user. Through an evaluation of the user form and stability during various actions (e.g., via analysis of data obtained from the sensors 513 or the like), the exoskeleton device 510 in some examples can identify if the user is highly skilled, novice, or beginner. This understanding of skill level or style can allow the exoskeleton system 100 to better tailor control references to the specific user.

In further embodiments, the exoskeleton system 100 can also use individualized information about a given user to build a profile of the user's biomechanic response to the exoskeleton system 100. One embodiment can include the exoskeleton system 100 collecting data regarding the user to develop an estimate of the individual user's knee strain in an effort to assist the user with understanding the burden the user has placed on his legs 102 throughout use. This can allow the exoskeleton system 100 to alert a user if the user has reached a historically significant amount of knee strain to alert the user that he may want to stop to spare himself potential pain or discomfort.

Another embodiment of individualized biomechanic response can be the system collecting data regarding the user to develop an individualized system model for the specific user. In such an embodiment the individualized model can be developed through a system ID (identification) method that evaluates the system performance with an underlying system model and can identify the best model parameters to fit the specific user. The system ID in such an embodiment can operate to estimate segment lengths and masses (e.g., of legs 102 or portions of the legs 102) to better define a dynamic user model. In another embodiment, these individualized model parameters can be used to deliver user specific control responses as a function of the user's specific masses and segment lengths. In some examples of a dynamic model, this can help significantly with the device's ability to account for dynamic forces during highly challenging activities.

In various embodiments, the exoskeleton system 100 can provide for various types of user interaction. For example, such interaction can include input from the user 101 as needed into the exoskeleton system 100 and the exoskeleton system 100 providing feedback to the user 101 to indicate changes in operation of the exoskeleton system 100, status of the exoskeleton system 100, and the like. As discussed herein, user input and/or output to the user can be provided via one or more user interface 515 of the exoskeleton device 510 or can include various other interfaces or devices such as a smartphone user device. Such one or more user interfaces 515 or devices can be located in various suitable locations such as on a backpack 155 (see e.g., FIG. 1), the pneumatic system 520, leg actuation units 110, or the like.

The exoskeleton system 100 can be configured to obtain intent from the user 101. For example, this can be accomplished through a variety of input devices that are either integrated directly with the other components of the exoskeleton system 100 (e.g., one or more user interface 515), or external and operably connected with the exoskeleton system 100 (e.g., a smartphone, wearable device, remote server, or the like). In one embodiment, a user interface 515 can comprise a button that is integrated directly into one or both of the leg actuation units 110 of the exoskeleton system 100. This single button can allow the user 101 to indicate a variety of inputs. In another embodiment, a user interface 515 can be configured to be provided through a torso-mounted lapel input device that is integrated with the exoskeleton device 510 and/or pneumatic system 520 of the exoskeleton system 100. In one example, such a user interface 515 can comprise a button that has a dedicated enable and disable functionality; a selection indicator dedicated to the user's desired power level (e.g., an amount or range of force applied by the leg actuator units 110); and a selector switch that can be dedicated to the amount of predictive intent to integrate into the control of the exoskeleton system 100. Such an embodiment of a user interface 515 can use a series of functionally locked buttons to provide the user 101 with a set of understood indicators that may be required for normal operation in some examples. Yet another embodiment can include a mobile device that is connected to the exoskeleton system 100 via a Bluetooth connection or other suitable wired or wireless connection. Use of a mobile device or smartphone as a user interface 515 can allow the user a far greater amount of input to the device due to the flexibility of the input method. Various embodiments can use the options listed above or combinations and variants thereof, but are in no way limited to the explicitly stated combinations of input methods and items.

The one or more user interface 515 can provide information to the user 101 to allow the user to appropriately use and operate the exoskeleton system 100. Such feedback can be in a variety of visual, haptic and/or audio methods including, but not limited to, feedback mechanisms integrated directly on one or both of the actuation units 110; feedback through operation of the actuation units 110; feedback through external items not integrated with the exoskeleton system 100 (e.g., a mobile device); and the like. Some embodiments can include integration of feedback lights in the actuation units 110, of the exoskeleton system 100. In one such embodiment, five multi-color lights are integrated into the knee joint 125 or other suitable location such that the user 101 can see the lights. These lights can be used to provide feedback of system errors, device power, successful operation of the device, and the like. In another embodiment, the exoskeleton system 100 can provide controlled feedback to the user to indicate specific pieces of information. In such embodiments, the exoskeleton system 100 can pulse the joint torque on one or both of the leg actuation units 110 to the maximum allowed torque when the user changes the maximum allowable user-desired torque, which can provide a haptic indicator of the torque settings. Another embodiment can use an external device such as a mobile device where the exoskeleton system 100 can provide alert notifications for device information such as operational errors, setting status, power status, and the like. Types of feedback can include, but are not limited to, lights, sounds, vibrations, notifications, and operational forces integrated in a variety of locations that the user 101 may be expected to interact with including the actuation units 110, pneumatic system 520, backpack 155, mobile devices, or other suitable methods of interactions such as a web interface, SMS text or email.

The communication unit 514 can include hardware and/or software that allows the exoskeleton system 100 to communicate with other devices, including a user device, a classification server, other exoskeleton systems 100, or the like, directly or via a network. For example, the exoskeleton system 100 can be configured to connect with a user device, which can be used to control the exoskeleton system 100, receive performance data from the exoskeleton system 100, facilitate updates to the exoskeleton system, and the like. Such communication can be wired and/or wireless communication.

In some embodiments, the sensors 513 can include any suitable type of sensor, and the sensors 513 can be located at a central location or can be distributed about the exoskeleton system 100. For example, in some embodiments, the exoskeleton system 100 can comprise a plurality of accelerometers, force sensors, position sensors, and the like, at various suitable positions, including at the arms 115, 120, joint 125, actuators 130 or any other location. Accordingly, in some examples, sensor data can correspond to a physical state of one or more actuators 130, a physical state of a portion of the exoskeleton system 100, a physical state of the exoskeleton system 100 generally, and the like. In some embodiments, the exoskeleton system 100 can include a global positioning system (GPS), camera, range sensing system, environmental sensors, elevation sensor, microphone, thermometer, or the like. In some embodiments, the exoskeleton system 100 can obtain sensor data from a user device such as a smartphone, or the like.

In some cases, it can be beneficial for the exoskeleton system 100 to generate or augment an understanding of a user 101 wearing the exoskeleton device 100, of the environment and/or operation of the exoskeleton system 100 through integrating various suitable sensors 515 into the exoskeleton system 100. One embodiment can include sensors 515 to measure and track biological indicators to observe various suitable aspects of user 101 (e.g., corresponding to fatigue and/or body vital functions) such as, body temperature, heart rate, respiratory rate, blood pressure, blood oxygenation saturation, expired CO₂, blood glucose level, gait speed, sweat rate, and the like.

In some embodiments, the exoskeleton system 100 can take advantage of the relatively close and reliable connectivity of such sensors 515 to the body of the user 101 to record system vitals and store them in an accessible format (e.g., at the exoskeleton device, a remote device, a remote server, or the like). Another embodiment can include environmental sensors 515 that can continuously or periodically measure the environment around the exoskeleton system 100 for various environmental conditions such as temperature, humidity, light level, barometric pressure, radioactivity, sound level, toxins, contaminants, or the like. In some examples, various sensors 515 may not be required for operation of the exoskeleton system 100 or directly used by operational control software, but can be stored for reporting to the user 101 (e.g., via an interface 515) or sending to a remote device, a remote server, or the like.

The pneumatic system 520 can comprise any suitable device or system that is operable to inflate and/or deflate the actuators 130 individually or as a group. For example, in one embodiment, the pneumatic system can comprise a diaphragm compressor as disclosed in related U.S. patent application Ser. No. 14/577,817 filed Dec. 19, 2014 or a pneumatic power transmission as discussed herein.

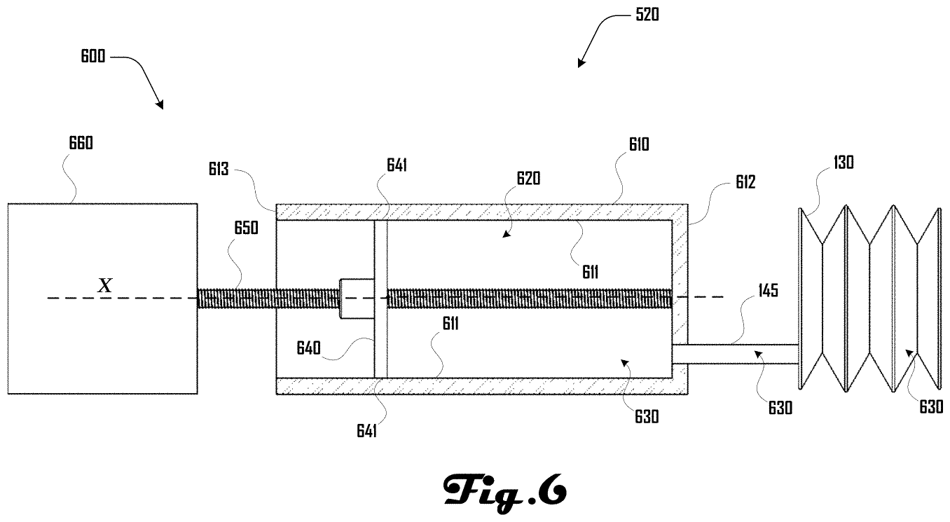

Turning to FIGS. 6-8, this disclosure teaches example systems and methods of a novel pneumatic power transmission 600 that can be uniquely suited for mobile robotic applications in some embodiments. One example architecture includes a mechanical power source that uses a closed pneumatic power transmission to relay the power to an output degree of freedom (e.g., a fluidic actuator 130) through a fluid medium. One preferred embodiment is a pneumatic power transmission 600 for use in pneumatic exoskeleton applications where the burden of distal weight and power efficiency can be especially pronounced in some examples. Accordingly, a mobile exoskeleton (e.g., a mobile, body worn robot such as the exoskeleton system 100 discussed herein) is used as an example of a system in which a pneumatic power transmission 600 can be used. However, it should be made clear that this is done for the purposes of clarity, and is in no way done to limit the general applicability to other embodiments where such a system, method or associated benefits provided can be of value. Similarly, the description discusses the use of air or other gas as the primary applicable fluid to be used in the described embodiments; however, this is also done for descriptive purposes as the systems and methods discussed herein can be equally applicable to any alternate fluid medium (e.g., gas and/or liquid fluid), which may be preferable in some embodiments for specific fluid properties.

FIG. 6 illustrates one example embodiment of a pneumatic power transmission 600 that can be part of pneumatic system 520 of an exoskeleton system 100 (See, e.g., FIG. 5). The pneumatic power transmission 600 comprises a transmission body 610, that defines a transmission chamber 620 configured to hold a fluid, with the transmission chamber 620 defining a portion of a larger working fluid volume 630 that comprises, consists of, or consists essentially of: working fluid present in the transmission chamber 620, fluid lines 145, and bellows actuator 130. For example, the transmission chamber 620 can be fluidically coupled to the bellows actuator 130 via the fluid lines 145, with a volume of working fluid being held within the transmission chamber 620, fluid lines 145 and bellows actuator 130.

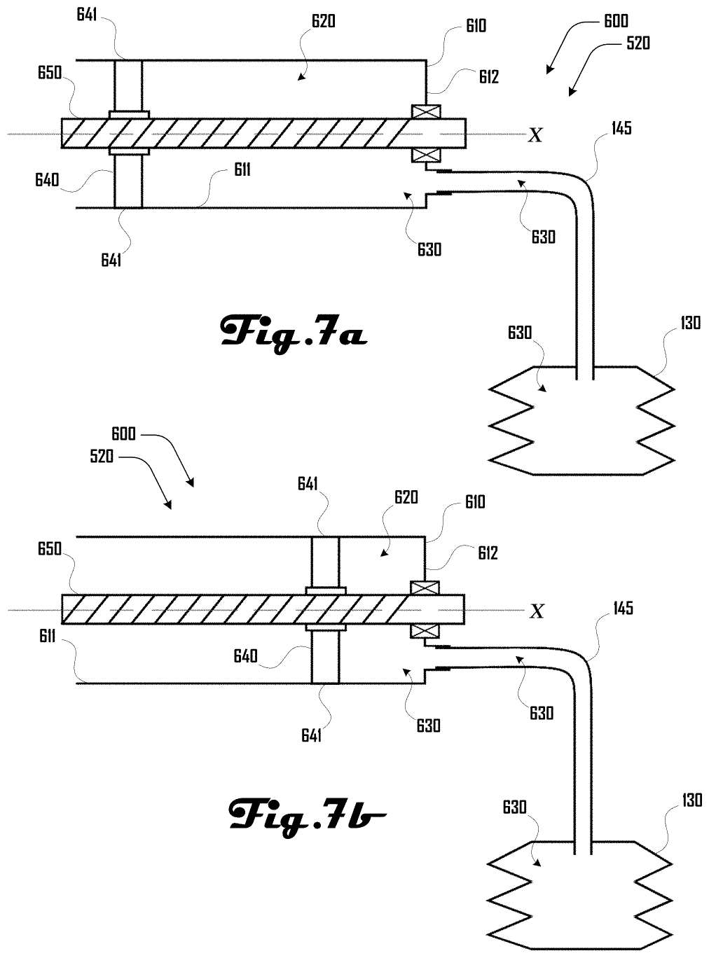

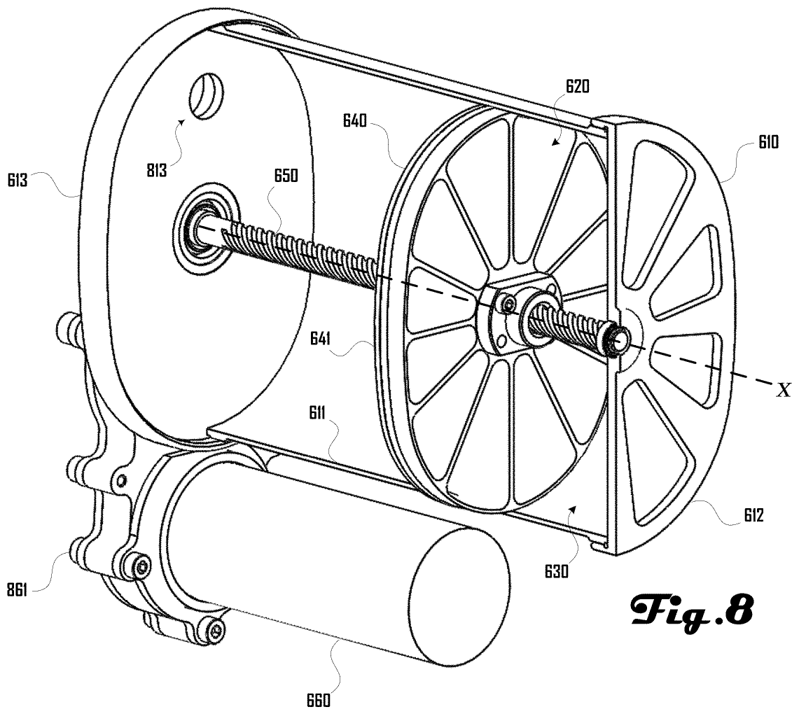

The pneumatic power transmission 600 can further comprise a piston 640 that translates within the transmission body 610 via a lead screw 650 (see e.g., FIGS. 7a and 7b) between a first and second end 612, 613 of the transmission body 610 to change the size or volume of the transmission chamber 620 as discussed herein. For example, peripheral edges 641 of the piston 640 can engage internal walls 611 of the transmission body 610 and generate a fluid-impermissible seal such that working fluid can be held within the transmission chamber 620. In some examples, the second end 613 of the transmission body 610 can be completely (e.g., as shown in FIG. 6), or can be mostly closed while allowing for air to enter and exit the second end 613 of the transmission body 610 (e.g., via an air flow port 813 as shown in FIG. 8).

As shown in the example of FIG. 6, the lead screw 650 can extend along an axis X within the transmission body 610, which can be parallel to a main axis of the transmission body 610. The lead screw 650 can be rotatably coupled at a first end 612 of the body 610 and extend to a mechanical power source 660 proximate to the second end 613, which can be configured to rotate the lead screw 650 to cause the piston 640 to translate within the transmission body 610 to change the size or volume of the transmission cavity 620. In some embodiments, the lead screw 650 can be rotatably coupled to an internal face of the body 610 within the transmission cavity 620; coupled within an internal face of the body 610 within the transmission cavity 620, or the like. For example, in some embodiments, the lead screw 650 can extend into or through the transmission body 610 at the first end 612 of the transmission body 610 (see, e.g., FIGS. 7a and 7b). Various embodiments exist that utilize different types of mechanical power sources 660 which can include but are not limited to electromechanical, hydraulic, or combustion sources. For example, one embodiment includes an electric motor that rotates the lead screw 650. Further embodiments can include linear motor, direct drive, electro-pneumatic positioner, hydraulic actuator, and the like.

The principal concept behind the operation of a pneumatic power transmission 600 in accordance with various embodiments can be different from that used in some pneumatic systems. For example, in some pneumatic systems the volume of the system is relatively constant and the pneumatic transmission is able to transmit the power to the target joint by introducing new air to the high pressure portion of the pneumatic system through use of the compressor. This can leverage the understood properties of the standard gas law where PV=nRT. In such a case, in order to augment the pressure (P), the pneumatic transmission increases the amount of gas included (n) in an otherwise stable volume (V). In contrast, various embodiments presented within this description can impact the pressure (P) by varying the volume (V) of the complete system without any major changes in the amount of gas included within the system (n).

For example, FIGS. 7a and 7b illustrate an example of a pneumatic power transmission 600 in a respective first and second configuration where the piston 640 is at different positions within the transmission body 610 along the length of the lead screw 650 such that the transmission cavity 620 defined by the piston 640 and the transmission body 610 is different sizes or volumes. FIG. 7a illustrates the first configuration where the transmission cavity 620 is larger or has a greater volume than the transmission cavity 620 in the second configuration shown in FIG. 7b. Specifically, FIG. 7a illustrates an example configuration where the piston 640 is positioned at a distance from first end 612 of the transmission body 610 in the first example configuration that is greater than the distance between piston 640 and first end transmission body 610 shown in the second configuration of FIG. 7b.

In various embodiments, the lead screw 650 can comprise threads that correspond to threads of the piston 640 such that rotating the lead screw 650 causes the piston to translate along the length of the lead screw 650. Accordingly, in various embodiments, rotating the lead screw 650 in a first direction can cause the piston 640 to translate along the length of the lead screw 650 from the first configuration to the second configuration and rotating the lead screw 650 in a first direction opposite to the first direction can cause the piston 640 to translate along the length of the lead screw 650 from the second configuration to the first configuration. While corresponding threads of the piston 640 and lead screw 650 can be used to generate movement of the piston 640 within the transmission body 610, further embodiments can include various other suitable systems for generating movement of the piston 640 within the transmission body 610. Additionally, some examples may not use a classical “piston” but instead use a soft-robotic-esque element of variable volume, where volume change is driven by an electro-mechanical actuator, or the like.

As discussed herein, the working fluid volume 630 can comprise, consist of, or consist essentially of: working fluid present in the transmission chamber 620, fluid lines 145, and bellows actuator 130. Accordingly, the size or volume of the working fluid volume 630 can be changed by changing the size or volume of the transmission chamber 620 as shown in the examples of FIGS. 7a and 7b. Additionally, in various embodiments, the fluidic actuator 130 can be configured to expand and contract, which can also cause a change in the size or volume of the working fluid volume 630. In various embodiments, the size or volume of the fluid lines 145 can remain generally constant aside from nominal expansion or contraction of flexible material that may define the fluid lines 145.

In embodiments where the amount of working fluid (e.g., air) remains constant within the working fluid volume 630, expanding and contracting the size or volume of the working fluid volume 630 can change the pressure of the working fluid within the working fluid volume 630. For example, the pressure of working fluid within the working fluid volume 630 can be at a lower pressure in the first configuration shown in FIG. 7a compared to a higher pressure of working fluid within the working fluid volume 630 in the second configuration shown in FIG. 7a.

While a bellows actuator 130 is illustrated in various examples herein, an output degree of freedom can be done in a variety of different ways which can include but are not limited to a linear actuating joint, a rotary actuating joint, a direct pneumatic actuator, or the transfer of the power within the pneumatic system to any suitable type of secondary power system. Accordingly, the examples of bellows or pneumatic actuators 130 discussed herein should not be construed to be limiting. Additionally, while various examples relate to fluidic actuators that elongate when the fluid is introduced to the actuators, further embodiments can include actuators that contract when fluid is introduced to such actuators.

As discussed herein, in some embodiments, the translation from mechanical power into the pneumatic transmission system 600 can be completed through the use of a mechanically coupled piston 640 that is driven by a mechanical power source 660. In one preferred embodiment, this is accomplished by connecting an electromechanical source power system or motor to the piston 640 within a closed pneumatic system comprising a lead screw 650. This can allow for the input torque from the motor to be translated to mechanical work on the pneumatic system by changing the available volume within the pneumatic chamber 620. Various embodiments can use other methods to transition the mechanical power into the pneumatic system without limiting the extensibility of the design in any way. These methods can include but are not limited to the use of a ball screw, use of a 4-bar linkage, use of a linear motor, use of a camshaft, or the like.

For example, while FIG. 6 illustrates one example embodiment of a pneumatic transmission system 600 where the mechanical power source 660 is aligned with and transmits rotational mechanical power to the lead screw 650 along the X-axis, in further examples the mechanical power source 660 can be oriented and transmit rotational power to the pneumatic transmission system 600 in various other suitable ways. For example, FIG. 8 illustrates another embodiment of a pneumatic transmission system 600 where the mechanical power source 660 is disposed adjacent to the length of the transmission body 610 instead of proximate to the second end 613 and coincident with the X-axis as shown in FIG. 6. In the example of FIG. 8 rotational mechanical power can be generated by the mechanical power source 660 transmitted to the lead screw 650 via a mechanical power coupling 861, which can comprise a chain, belt, gear assembly, or the like, coupled between the mechanical power source 660 and lead screw 650.

In another example, while some embodiments of a mechanical power source 660 can include a linear drive shaft or other coupling that may require alignment of the mechanical power source 660 with the X-axis as shown in FIG. 6, further embodiments can comprise a non-linear or flexible drive shaft or coupling that may allow the mechanical power source 660 to be oriented at various suitable angles relative to an X-axis of the lead screw 650. For example, in some embodiments, a drive shaft of the mechanical power source 660 or coupling between the mechanical power source 660 and drive screw 650 can comprise a flexible coil such that mechanical power source 660 can be oriented, at an angle (e.g., 10°, 20°, 30°, 40°, 50°, 60°, 90°, 120°, 150°, 180°, or the like) relative to the an X-axis of the lead screw 650. In such embodiments, such an angle can be fixed or can be variable. For example, where a flexible drive shaft or coupling extends over a joint of a user or portion of a user that may flex (e.g., the back or spine), the coupling between the mechanical power source 660 and drive screw 650 can flex or bend to accommodate movement of the user while allowing the mechanical power source 660 to impart mechanical rotational energy on the drive screw 650.

At times, and in some embodiments input power can go through a mechanical transmission to convert the power available into a desirable spectrum of torque and speeds for a given application. In one embodiment, the use of an electromechanical power source in the form of a DC brushless motor can comprise a mechanical transmission to gear down the power, which may amplify the torque of the input power and reduce the operating speeds such that the operating speed is well suited for mechanical constraints of a given pneumatic drive system. There are various methods by which the transmission between the mechanical power source and the pneumatic chamber can be accomplished which can include but are not limited to a belt driven transmission, a planetary gear transmission, a multiple stage transmission, a harmonic transmission, or a friction driven transmission. For example, the mechanical power coupling 861 of FIG. 8 can comprise a mechanical transmission to convert rotational power generated by the mechanical power source 660 available into a suitable spectrum of torque and speeds applied to the drive screw 650. Some embodiments can include a speed reduction mechanism such as a gearbox, timing belt, or the like, between the mechanical power source 660 and the lead screw 650.

With various pneumatic systems 520, a practical concern that some embodiments may elect to address is the likelihood of small amounts of leakage out of the pneumatic system 520. For some pneumatic systems 520, this may not be a critical issue because the pneumatic system 520 operates by continuously replenishing working fluid (e.g., air) within the working fluid volume 630 by pulling in new working fluid through a compressor or via other suitable method.

A direct-driven pneumatic transmission (e.g., pneumatic power transmission 600) can be different in various embodiments as such a direct driven pneumatic transmission can operate through varying the volume within the pneumatic system 520. Some embodiments can include design elements to allow the pneumatic system 520 to refill working fluid (e.g., air) lost to the environment. One preferred embodiment can comprise a passive check valve that communicates with the transmission chamber 620 (or other suitable portion of the working fluid volume 630) and is connected to the atmospheric pressure. In such an embodiment, such a refill valve can be positioned in the transmission chamber 620 where it can be equal to atmospheric pressure. In one example scenario where the pneumatic transmission leaks working fluid, the chamber pressure within the transmission chamber 620 can drop below atmospheric pressure and can allow the check valve to flow air back into the pneumatic system 520 to refill the lost working fluid. Various embodiments can use other systems and methods for refilling the lost working fluid which can include but are not limited to: a dedicated stored-air high-pressure refill system; a compressor-charged high-pressure refill system; a small refill compressor connected directly to the primary pneumatic system; an actively controlled refill valve connected to either the atmosphere or other source chamber, or the like.

In some embodiments, it is beneficial to include design adaptations to accommodate for safety in the event of an overpressure scenario. In one preferred embodiment, the pneumatic transmission 600 includes a pressure blow-off valve that is connected to atmospheric pressure and can be designed to open when the transmission chamber 620 goes above an identified maximum pressure. The selected maximum pressure can be entirely dependent on the desired system application, but these selected pressures can include but are not limited to 0 psi, 15 psi, 30 psi, 60 psi, 120 psi, and the like. For example, some embodiments can include a blow-off valve disposed in the transmission body 610 that provides a release for fluid within the transmission chamber 620 to the environment external to the transmission chamber 620. Various embodiments can include this design consideration in a variety of ways that can include but are not limited to a pressure relief valve, an electronically controlled pressure exhaust valve, and the like.

The characteristics of the design of the transmission body 610 that defines the transmission chamber 620 can be important in some embodiments. Design considerations for the transmission body 610 in various examples can include designing a static volume of the transmission chamber 620. In one embodiment, the pneumatic transmission 600 can be connected to a fluidic actuator 130 that defines a 1-liter actuator chamber and has a targeted operating pressure range of 0-20 psi throughout the range of the fluidic actuator 130. To accomplish this, in various examples the source transmission chamber 620 can be sized to meet the two most extreme operating scenarios of the fluidic actuator 130, which can be the lowest system volume (actuator closed) at the lowest target pressure, and the maximum system volume (actuator extended) at the highest target pressure. Another design consideration can be the geometry of the primary transmission chamber 620. It is possible to achieve a target chamber volume with a variety of geometries, but one specific design may work better given the target application and the available mechanical constraints imposed by the mechanical power source 660 or other components. It is important to note that these design considerations can be considered integral parts of some embodiments and the selection of a specific set of design criteria can be done in various suitable ways. It should also be noted that a selected operating pressure range in various embodiments can be determined by the designer or operator of an exoskeleton system 100 and the examples of operating pressure ranges herein should not be seen as limiting in any way and an exoskeleton system 100 of further examples can be designed to operate within any suitable range of realizable pressures.

In some embodiments, it can be desirable to resist, limit or constrain the freedom of the piston 640 in the primary transmission chamber 620 to rotate while the piston 640 is moving within transmission chamber 620. Specifically, in an embodiment that includes a lead screw 650 that drives a piston 640, if the piston 640 were to rotate freely within the transmission chamber 620, the piston 640 could fail to translate within the transmission body 610 and impart mechanical work on pneumatic fluid disposed in the transmission chamber 620. In one embodiment, a configuration that includes a lead screw 650 as a drive mechanism can use a non-circular piston 640 such that the mechanical interaction between the piston 640 and the internal wall 611 of the transmission body 610 acts as a derotating feature. In another embodiment, a lead screw configuration can include one or more guiding rods that run the length of the primary transmission chamber 620 parallel to the lead screw 650 between the first and second ends 612, 613 of the transmission body in order to fight, resist or limit the rotation of the piston 640. Various additional embodiments can include but are not limited to an oval piston head, a keyed piston head that includes a mating feature on the chamber wall, an off-center lead screw 650, or the like. For example, FIG. 8 illustrates an example of a piston 640 having an oval shape. A piston 640 in some embodiments can have various shapes, including shapes with only smooth edges without any corners and/or linear edges. However, in further embodiments, the piston 640 can have a shape with corners and/or linear edges, such as a triangle, square, pentagon, hexagon, octagon, or other polygon, a Reuleaux polygon, and the like. The shape of the piston 640 can comprise various planes of radial symmetry including zero, one, two, three, four, five, six, eight, and the like.

In some embodiments, it may prove desirable to have additional control over the specific behavior of the bellows actuator 130 in an effort to accentuate the overall system performance. In one set of embodiments, a pneumatic system 520 can include additional valving within the pneumatic transmission system 600 to control the air flow into and out of the actuator 130. In one embodiment, the pneumatic system 520 and/or actuator 130 can include an inlet control valve that controls the flow area into the bellows actuator 130. Such a design can provide discrete restriction of flow rate into and out of the bellows actuator 130 in some examples and can provide a low-power alternative to support the delivery of damping styled forces at the joint 125 of an exoskeleton system 100 by restricting the flow out of the bellows actuator 130 under load. Such a valve can be located in various suitable locations, including at a connection between the bellows actuator 130 and fluid lines 145; a connection between transmission body 610 and fluid lines 145; at the transmission body within the transmission chamber 620 or the transmission body 610; along or within fluid lines 145; within or as part of the body of the actuator 130, or the like.

In another embodiment, the bellows actuator 130 or other portion of the exoskeleton system 100 can include an exhaust valve configured to communicate fluid between the bellows actuator 130 and the environment external to the bellows actuator 130. Such a design, in various examples, can allow the exoskeleton system 100 to quickly vent the pressure to atmospheric in an effort to rapidly deflate the exoskeleton system 100 based on a safety issue or other desired response. System venting can include one or both of a controllable inlet and exhaust valve on the bellows actuator 130 in some examples. One or more venting valves or structures can be located at various suitable locations, including at a connection between the bellows actuator 130 and fluid lines 145; a connection between transmission body 610 and fluid lines 145; at the transmission body within the transmission chamber 620 or the transmission body 610; along or within fluid lines 145; within or as part of the body of the actuator 130, or the like.

While some embodiments, can include valving to control flow into or out of the bellows actuator 130, transmission chamber 630, fluid lines 145, or the like, in further embodiments, valving can be specifically absent from various portions of an exoskeleton system 100, pneumatic system 520, pneumatic power transmission 600, fluid lines 145, actuator 130, couplings thereof, or the like. In some embodiments, valving can be absent from such portions of an exoskeleton system 100 aside from safety valving such as an emergency pressure release valve, or the like.

With some embodiments of a pneumatic power transmission 600, there are a number of possible ways that the pneumatic power transmission 600 can be deployed to meet the power needs of a given exoskeleton system 100. While some descriptions herein describe the architecture of an exoskeleton system 100, the system level design associated with how an exoskeleton system 100 is deployed can be important to the overall function of the exoskeleton system 100 in some examples. This can be even more important in some embodiments of exoskeleton system 100 that have multiple controllable degrees of freedom as various design considerations can allow for improved system performance. Some example system configurations that can be deployed in various embodiments are described below.

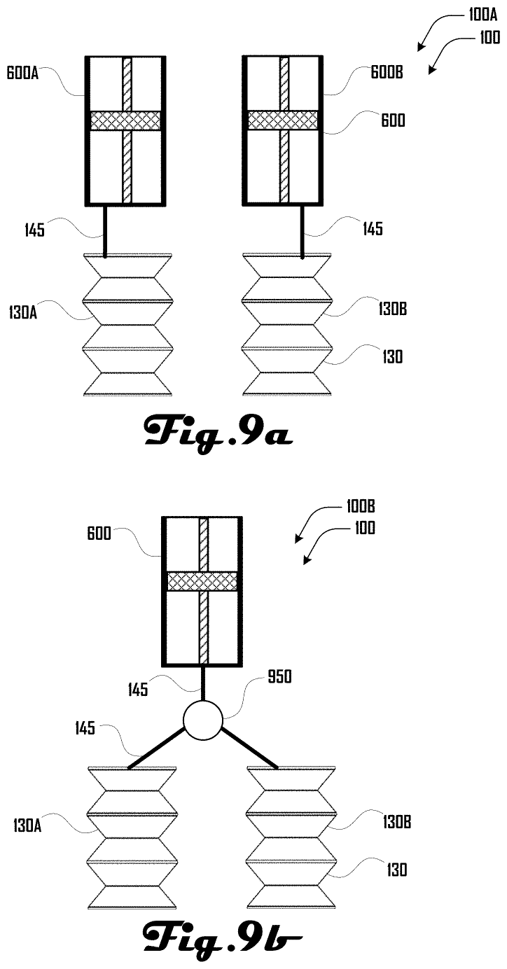

One system configuration can be designed to assign one actuation unit to a single degree of freedom on an exoskeleton system 100. In one embodiment, a pneumatic system 520 can be configured to power a lower extremity exoskeleton system 100 that comprises, consists of or consists essentially of two powered knee actuator units 110L, 110R (e.g., as shown in FIGS. 1 and 5). To power such an exoskeleton system 100, a pneumatic system 520 can comprise a first and second pneumatic power transmission 600 that are respectively associated with left and right knee actuator units 110L, 110R. For example, such a system can include two independently operating pneumatic transmission systems 600 that respectively actuate left and right knee actuator units 110L, 110R. Similarly, FIG. 9a illustrates a first example embodiment 100A of an exoskeleton system 100 comprising a first pneumatic transmission system 600A fluidically coupled to a first fluidic actuator 130A and a separate second pneumatic transmission systems 600B fluidically coupled to a second fluidic actuator 130B.

Additionally, while some embodiments, can include two completely separate pneumatic transmission systems 600, in some embodiments, two or more transmission systems 600 can be configured to operate independently while being physically associated, coupled or integrated in various ways. For example, some embodiments of a pneumatic transmission system 600 can comprise a transmission body 610 that defines a separate first and second transmission cavity 620, with respective first and second pistons 640 that translate within the first and second transmission cavity 620. The first and second transmission cavity 620 can be associated with a respective first and second fluidic actuator 130. In various embodiments of such a configuration, the first and second pistons 640 can be independently actuated by a respective first and second mechanical power source 660 to control the respective first and second fluidic actuators 130 separately. Similarly, in some embodiments, mechanical power sources 660 can be completely separate or physically associated, coupled or integrated in various ways. For example, in some embodiments two or more independently controllable mechanical power sources 660 can share a common housing, body, electrical power source, or the like.

It should be noted that, in various examples, an independent pneumatic and mechanical configuration does not limit the ability of the separate actuator units 110 (left and right knee actuator units110L, 110R) to be operated in concert as electrical and software planning (e.g., implemented via an exoskeleton device 510) can operate the two mechanically independent systems to produce a desired coordinated motion as discussed herein. Also, systems such as mechanical power sources 660 and/or transmission bodies 610 can disposed on the body of a user 101 separately or in a common location (e.g., in a backpack 155).

In other embodiments of this configuration, the number of mechanically and pneumatically independent systems can scale along with the number of controlled degrees of freedom (e.g., fluidic actuators 130) with each independently sized and designed to meet the needs of the target joint to which the exoskeleton system 100 is attached. As discussed herein, any suitable joint of a body can be targeted by one or more actuators in various embodiments, including one or more of a toe, ankle, knee, hip, shoulder, elbow, wrist, finger, neck, or the like. Accordingly, examples herein related to a left and right knee actuator unit 110L, 110R should not be construed as being limiting and are only used as examples of some embodiments of an exoskeleton system 100.

Another system configuration can be designed to connect a pneumatic transmission system 600 to multiple powered degrees of freedom (e.g., to multiple separate fluidic actuators 130). For example, FIG. 9b illustrates another example embodiment 100B of an exoskeleton system 100 that comprises a single pneumatic power transmission 600 coupled to a first and second fluidic actuator 130A, 130B via valving 950 that can be configured to control fluid flow between the single pneumatic power transmission 600 and one or both of the first and second fluidic actuators 130A, 130B at a given time.

Such a design configuration can present a much more coupled style of behavior between multiple actuator unit 110; however, in some scenarios such a configuration can produce a suitable performance while reducing the infrastructure required to power those actuator units 110 in terms of system complexity, weight and/or size. In one embodiment, a powered exoskeleton system 100 with a left and right knee actuator unit 110L, 110R can be designed to assist with the impact associated with heel strike only during walking, running, or the like. Due to a limited scope of the need at the joint of the user in some examples, the bellows actuators 130 in some embodiments do not require overlapping power addition (e.g., via two separate pneumatic transmission systems 600).

Accordingly, in some embodiments, by adding a selector valve (e.g., valving 950) between first and second actuators 130A, 130B (e.g., of a left and right actuator unit 110L, 110R), the power from a single pneumatic power transmission 600 can be redirected between the left knee and the right knee actuators 130A, 130B based on when the use case is most significant. In another embodiment, a single pneumatic power transmission 600 can be configured to assist with damping the forces of descending stairs at the knees of a user (e.g., via a left and right actuator unit 110L, 110R). In this case, the force profiles for a left and right actuator unit 110L, 110R may not be entirely independent, but there can be a significant phase delay in the peak power requirement of each leg.

As a result, an exoskeleton system 100 in some examples can include one or more controlled valves (e.g., valving 950) moving between a single transmission chamber 620 of a pneumatic power transmission 600 and respective actuators 130A, 130B of the left and right actuator units 110L, 110R. When the transmission chamber 620 generates power, the one or more control valves can be used to restrict and/or enable the pneumatic power flow to each of the bellows actuators 130. This can enable a desired amount of power to enter each of the individual bellows actuators 130 and the transmission chamber 620 of a single pneumatic transmission 600 may only be required to be sized such that the transmission chamber 620 supports a maximum power configuration of the bellows actuators 130 associated with the transmission chamber 620.

One or more valves (e.g., valving 950) can control the flow of fluid into and/or out of two or more bellows actuators 130 in various suitable ways. For example, some embodiments can provide a binary on/off for fluid flow to/from the bellows actuators 130 where states of two valves for two bellows actuators 130 for example can include on/on, off/off, on/off and off/on. Another embodiment can provide a switch between two or more bellows actuators 130. For example, a switch valve between a first and second bellows actuator 130 and include states of on/off or off/on. In further embodiments, flow rate of fluid into or out of two or more bellows actuators 130 can be controlled along a spectrum or at various suitable increments and such control between actuators 130 may or may not be dependent. For example, a dependent flow rate to/from two actuators 130 can generate example states of 20/80%, 40/60%, 50/50%, 60/40%, 80/20%, or the like. In another example, independently configurable flow rate to/from two actuators 130 can generate example states of 20/20%, 30/60%, 80/20%, 90/90%, or the like. Various embodiments exist of such a configuration with multiple bellows actuators 130 connected to a single pneumatic power transmission 600, and within the scope and spirit of the present specification so the examples herein should not be construed as being limiting.

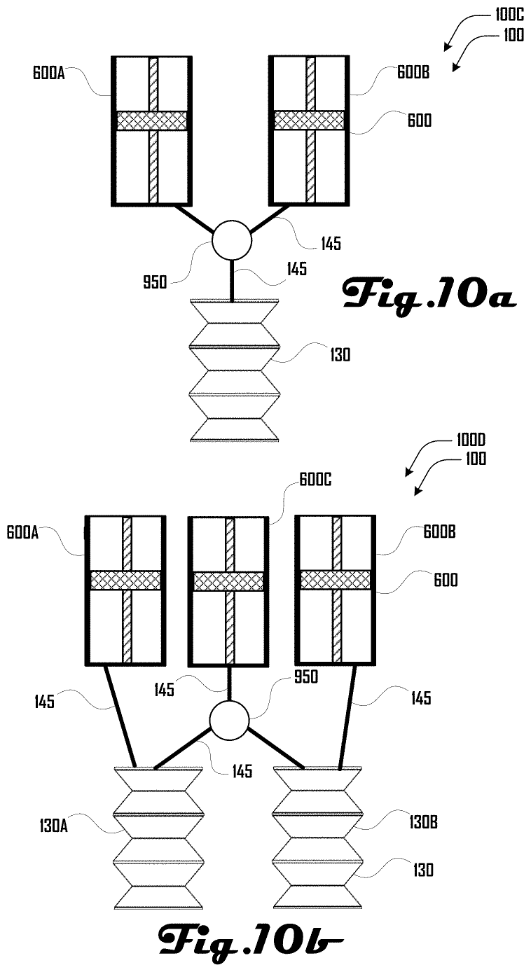

Another configuration for a pneumatic exoskeleton system 100 can be designed to connect multiple independent pneumatic transmission systems 600 to a single powered degree of freedom (e.g., a fluidic actuator 130). For example, FIG. 10a illustrates a further example embodiment 100C of an exoskeleton system 100, comprising a first and second pneumatic transmission system 600 coupled to a single fluidic bellows actuator 130 via valving 950. A potential benefit of such a configuration in some examples can be adaptability of the exoskeleton system 100 where power requirements for a joint vary significantly in different operating conditions or require a dynamic range that cannot be, or is not desirable for being achieved via a single pneumatic transmission system 600.

In one example, an exoskeleton system 100 with two independent pneumatic transmission systems 600A, 600B can be designed such that only one of the pneumatic transmission systems 600 is used during some operating conditions and then the second pneumatic transmission 600 can be recruited as needed to operate in addition to the first pneumatic transmission 600 in some operating conditions (e.g., in an operating condition where higher-power and/or faster dynamic range is desirable). In one embodiment, two pneumatic transmission systems 600 can be connected to a single leg actuation unit 110. The pneumatic transmission systems 600 in some such examples can be designed such that the first transmission system 600A supports the power requirements associated with swing phase behaviors and the other second transmission system 600B can be designed to provide additional power (i.e., in combination with the first transmission system 600A) for stance phase behaviors. Various embodiments of such a system configuration exist with some including the characteristic of having multiple pneumatic transmissions 600 connected to a single powered degree of freedom.

Similarly, some embodiments can comprise a plurality of fluidic bellows actuators 130 that are powered by separate respective pneumatic transmissions 600 and also by a pneumatic transmission 600 that is configured to provide additional power to one or more of the plurality of the fluidic actuators 600. For example, FIG. 10b illustrates an example embodiment 110D of an exoskeleton system 100 that comprises a first, second and third pneumatic transmission 600A, 600B and 600C where the first and second pneumatic transmissions 600A, 600B are connected exclusively and respectively to a first and second fluidic actuator 130A, 130B. The third pneumatic transmission 600C of FIG. 10b is configured to be fluidically coupled to one or both of the first and second fluidic actuators 130A, 130B via valving 950. For example, the first and second pneumatic transmissions 600A, 600B of FIG. 10b can be fluidically coupled to the first and second fluidic actuators 130A, 130B similar to the embodiment 100A of FIG. 9a, and the third pneumatic transmission 600C of FIG. 10b can be fluidically coupled to the first and second fluidic actuators 130A, 130B similar to the embodiment 100B of FIG. 9b.

Further system configurations can be designed to comprise or generate a network between a plurality of pneumatic transmission systems 600 and a plurality of powered degrees of freedom (e.g., fluidic bellows actuators 130). Such configurations may allow an exoskeleton system 100 to share the power capacity in the pneumatic system 520 generated by the plurality of pneumatic transmission systems 600 across the plurality of pneumatic bellows actuators 130. The total pneumatic system 520 can still have a peak pneumatic power output capability that may be defined by the design of the individual pneumatic transmission systems 600, but by interconnecting the various powered degrees of freedom (e.g., fluidic bellows actuators 130) in various examples, pneumatic power can be leveraged across any powered degree of freedom in the exoskeleton system 100 rather than being dedicated to a single powered degree of freedom.

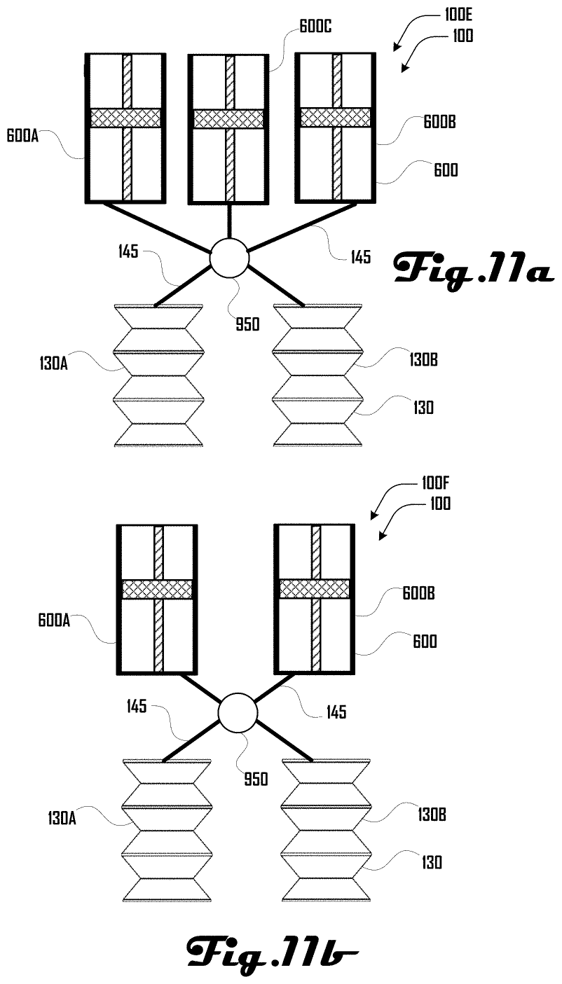

For example, FIG. 11a illustrates another embodiment 100E of an exoskeleton system 100 that comprises a first, second and third transmission system 600A, 600B, 600C that are configured to be fluidically coupled to a first and second fluidic actuator 130A, 130B via valving 950. The valving 950 can allow one or more of the first, second and third transmission system 600A, 600B, 600C to be fluidically coupled to one or both of the first and second fluidic actuators 130A, 130B at a given time. For example, the valving 950 can cause one or more of the first, second and third transmission systems 600A, 600B, 600C to be fluidically coupled to only the first fluidic actuator 130A; to only the second fluidic actuator 130B; or to both the first and second fluidic actuators 130A, 130B at the same time.

In one embodiment, a dual knee-powered exoskeleton can be configured with two pneumatic power transmission units 600 (e.g., as shown in FIGS. 1 and 5). The pneumatic system 520 can be interconnected with valving 950 that allows each power transmission unit 600 to be selectively plumbed to one or both of the leg actuation units 110L, 110R as desired. For example, FIG. 11b illustrates an example embodiment 100F having such a configuration. The power transmission units 600 in such an embodiment can be sized to meet the average power needs of each degree of freedom (e.g., each fluidic bellows actuator 130) with the power transmission units 600 being controlled to direct excess power to the other leg actuator unit 110 when needed. Various embodiments of such a system configuration can exist with a variety of numbers of degrees of freedom and power transmission units 600, and various embodiments can comprise characteristics of having two or more of powered degrees of freedom (e.g., two or more fluidic bellows actuators 130) interconnected through a series of valves to a two or more of power transmission systems 600.

It is important to note that the above configurations are representative configurations and not intended to be limiting or an attempt to communicate all potential system configurations. Other configuration variants can include any suitable collection of one or more pneumatic transmission systems 600 and one or more powered degrees of freedom (e.g., one or more fluidic actuators 130). Accordingly, it should be clear that the examples of FIGS. 9a-11b can be applied to exoskeleton systems 100 having any suitable plurality of fluidic bellows actuators 130 (e.g., two, three, four, five, six, seven, eight, nine, ten, twelve, fifteen, twenty five, fifty, one hundred, and the like) and any suitable plurality of pneumatic transmission systems 600 (e.g., two, three, four, five, six, seven, eight, nine, ten, twelve, fifteen, twenty five, fifty, one hundred, and the like). For example, some embodiments can include a plurality of the same or different sets of transmission system(s) 600 and fluidic bellows actuator(s) 130 in accordance with any of the example embodiments 100A, 100B, 100C, 100D, 100E, 100F. Similarly, the number of interconnected transmission system(s) 600 and fluidic bellows actuator(s) 130 can be any suitable number. For example, while the example embodiment 100E comprises three transmission systems 600 and two fluidic actuators 130, further embodiments can include any suitable plurality of such elements (e.g., three, four, five, six, seven, eight, nine, ten, twelve, fifteen, twenty five, fifty, one hundred, and the like). Accordingly, aspects of the example embodiments should be construed to be interchangeable as suitable and not necessarily limited to only that given embodiment. Also, the introduction herein of example design approaches to sizing the various components of the system does not limit the applicability or extensibility of these configurations. Similarly, a complex system can include any combination of the configurations described above without limiting the broad applicability of the invention described herein.

Various suitable methods can be used to control the behavior of an exoskeleton system 100. For example, a common objective for an individual degree of freedom (e.g., fluidic bellows actuator 130) in a robotic system can be to control the degree of freedom to meet a desired low-level target performance. In particular, it can be beneficial in various examples to be able to control to match a position, force, pressure, or velocity reference.

In one embodiment, an exoskeleton device 510 (see FIG. 5) can be configured to target a desired pressure reference in an exoskeleton system 100 that has a single degree of freedom (e.g., fluidic bellows actuator 130) directly connected to a single power transmission system 600. For example, when the exoskeleton device 510 detects that pressure of a bellows actuator 130 is lower than a target pressure (e.g., via one or more sensors 513), the pneumatic system 520 can input new power into the bellows actuator 130 by causing the pneumatic power transmission 600 to move more air into the actuator 130 to increase the pressure within the actuator 130. For example, a determination can be made by an exoskeleton device 510 based on data from one or more pressure sensors 513 that the pressure within a fluidic bellows actuator 130 is below a target pressure. In response, the exoskeleton device 510 can cause the mechanical power source 660 to move the piston 640 of the pneumatic power transmission 600 to make the transmission chamber 620 smaller, which increases the pressure within the transmission chamber 620, which in turn increases the pressure within the fluidic actuator 130.

Similarly, when the exoskeleton device 510 senses that pressure of a bellows actuator 130 is lower than a target pressure (e.g., via one or more sensors 513), the pneumatic system 520 can operate the opposite way and can remove power from the bellows actuator 130 by mechanically pulling the piston 640 back and increasing the volume of the transmission chamber 620 (and thereby the working fluid volume 630), which can lower the pressure within the bellows actuator 130. For example, a determination can be made by an exoskeleton device 510 based on data from one or more pressure sensors 513 that the pressure within a fluidic bellows actuator 130 is above a target pressure. In response, the exoskeleton device 510 can cause the mechanical power source 660 to move the piston 640 of the pneumatic power transmission 600 to make the transmission chamber 620 larger, which increases the pressure within the transmission chamber 620, which in turn increases the pressure within the fluidic actuator 130.

In some embodiments, a method of operating an exoskeleton device 100 can include determining a pressure within a fluidic bellows actuator 130; determining whether the pressure is above, below or equal to/within a target pressure or target pressure range; and determining whether to move a piston 640 of pneumatic power transmission 600 based at least in part on the determination whether the pressure is above, below or equal to/within a target pressure or target pressure range. For example, where a determination is made that pressure of an bellows actuator 130 is at, close to, or within a target pressure range or value, a determination can be made that moving the piston 640 is not necessary; however, where a determination is made that pressure of an actuator 130 is above or below a given target pressure or pressure range, a determination can be made that moving the piston 640 is necessary.

Where a determination is made that moving the piston 640 is necessary, a determination can be made regarding a distance or amount to move the piston 640 from a current location and then the piston 640 can be moved the determined distance or amount from a current location. For example, as discussed herein, changing the position of the piston 640 within the body 610 of the pneumatic power transmission 600 changes the volume or size of the transmission chamber 620, which in turn changes the volume or size of the working fluid volume 630.

In some embodiments, determining a distance or amount to move the piston 640 can be based on a determined or known volume of the working fluid volume 630, or portions thereof (e.g., the transmission chamber 620, fluid lines 145 an and/or fluidic bellows actuator(s) 130) and a pressure associated with various portions of the exoskeleton system 100 such as the transmission chamber 620, fluid lines 145 an and/or fluidic actuator(s) 130. For example, volume of the transmission chamber 620 can be determined based on a position of the piston 640, rotation of the lead screw 650, and the like. Volume of a fluidic bellows actuator 130 can be determined based on a configuration of the fluidic bellows actuator 130 (e.g., how physically compressed or expanded the fluidic actuator 130 is). Volume of fluid lines 145 can be a static and known volume, and in some embodiments can be considered to be a negligible volume. Pressure of the working fluid volume 630, or portions thereof can be based on one or more sensors 513 (e.g., pressure sensors) located at the transmission chamber 620, fluid lines 145 and/or fluidic actuator(s) 130.

In another embodiment, such an exoskeleton system 100 can include a position sensor on the degree of freedom (e.g., the fluidic bellows actuator 130) as a form of feedback and the exoskeleton device 510 can use data from the position sensor to track a desired target position of the degree of freedom. For example, a position sensor can indicate an amount that a fluidic bellows actuator 130 is expanded or contracted, which can correspond to a volume of the fluidic bellows actuator 130. Similar to the examples discussed above, the exoskeleton device 510 can obtain data from a position sensor associated with a fluidic bellows actuator 130 indicating that the fluidic bellows actuator 130 is in a more compressed state compared to a target state, and the exoskeleton device 510 can cause the piston 640 of a pneumatic transmission 600 to reduce the size of a transmission cavity 620, which increases fluid pressure within the transmission cavity 620 and in turn increases the pressure within the fluidic bellows actuator 130 that can cause the fluidic bellows actuator 130 expand toward the target state.

Various embodiments can be configured for controlling for a desired position, velocity, acceleration, pressure, force, torque, or the like, of one or more fluidic bellows actuator 130, which can cause an exoskeleton system 100 to support a use in various suitable actions as discussed herein. For example, in addition to controlling the position of one or more piston 640 of one or more transmission cavity 620 to control the pressure of one or more fluidic bellows actuators 130, an exoskeleton device 510 can further determine a suitable way to move a piston 640 from a first position to a second position, including a rate or speed of moving from the first position to the second position; pulsing movement from the first position to the second position; and the like.

In some embodiments, movements of one or more piston 640 can be based at least in part on a pre-programed movement set, which in some examples can correspond to movements of an exoskeleton system 100 that may be triggered by a user, administrator or automatically by the exoskeleton system 100 such as standing, walking, sitting, lifting, or the like. Such a pre-programmed movement set can be modified in some examples based on data obtained from one or more sensors 512. For example, a user can trigger a standing movement, which can cause a pre-programed movement set for one or more pistons 640 to be executed, and the execution of such movements can be fine-tuned, tweaked, modified, or the like based at least in part on data obtained from one or more sensors 512 of the exoskeleton system 100. Additionally, while various examples discussed herein relate to moving one or more pistons 640 of one or more power transmissions 600 to facilitate movement of an exoskeleton system 100, further embodiments can including actuating valving (e.g., valving 950 of FIGS. 9b-11b) or the like.

In some cases, it can be desirable to quickly exhaust the pneumatic system 520, fluidic bellows actuators 130, and the like, in an effort to remove an actuation force from the user. In some exoskeleton systems 100, this can be accomplished through a controllable valve to exhaust the pressure in one or more bellows actuator 130, or portion of the pneumatic system 520 to the environment. However, in some embodiments of a pneumatic power transmission 600, a pneumatic circuit or working volume 630 can remain closed to the environment making direct exhaust unallowable or impossible. To account for this, some embodiments of the pneumatic power transmission 600 can be configured to pull the system pressure to below atmospheric pressure in an effort to reduce the gauge pressure of one or more bellows actuators 130 to zero, near zero, to a pressure that substantially removes actuation force from the user, and the like. This can be accomplished in some examples by designing the volume of the pneumatic chamber 620, such that at a maximum volume of the pneumatic chamber 620, the pressure in the pneumatic chamber 620 is reduced to below atmospheric pressure. In one embodiment, a single leg knee exoskeleton is designed with a single pneumatic power transmission system that has an operable range of −5 psi to 30 psi. The −5 psi can be a gauge pressure that is 5 psi below atmospheric pressure and can enable air in the bellows actuator 130 to flow quickly out of the bellows actuator 130 to lower the pressure within the bellows actuator 130, which can increase the responsiveness of the control system in various examples.

In some cases it may be beneficial to design and control the pneumatic system 620, pneumatic line(s) 145, and/or fluidic bellows actuator(s) 130 to leverage the passive dynamics of such elements. For example such elements have both a spring constant and a damping effect associated with their passive dynamics in some examples. In one embodiment, the exoskeleton device 510 can generate a desired spring rate at the bellows actuator(s) 130 by controlling the pneumatic chamber(s) 620 to a desired volume target, which along with the compressibility of the fluid therein, can create the specific desired spring constant at the bellows actuator(s) 130. In another embodiment, the exoskeleton device 510 seeks to implement a desired damping constant at one or more joints through partially closing a control valve that is positioned in-line with a pneumatic system 520, pneumatic line(s) 145, bellows actuator(s) 130, or the like, in an effort to restrict air flow.

Various embodiments can generate spring rate and/or dampening in a variety of ways and can include any suitable combination of these objectives without losing the general applicability of the method described above. In various examples, the exoskeleton system 100 can control the inputs to adapt the passive dynamics of an actuation system in such a way that the exoskeleton device 510 can achieve a desired behavior without requiring the speed and control bandwidth required to keep up with dynamic behaviors.

One example embodiment includes a closed air system comprising a pneumatic bellows actuator 130 and pneumatic transmission 600, where a piston 640 can be driven to increase or reduce the overall volume of a working fluid volume 630 to achieve a target pressure within the pneumatic bellows actuator 130. This can be done actively in some examples, using one or more pressure sensors to detect system pressure in real-time, and adjust piston speed and/or position based on readings from such sensors. The piston 640 can be directly driven in some examples by a motor with a nominally rigid connection to a ball screw. A nut of the piston 640 can convert the rotational motion of the ball screw into linear motion of the piston 640. Further embodiments can comprise a screw component of any suitable profile or type, including a trapezoidal screw, acme screw, ball screw, lead screw or the like. Additionally, while various examples herein illustrate a pneumatic transmission 600 having a single piston 640 actuated by a single lead screw 650, further embodiments can include a piston 640 that is actuated by two or more screws rotating in coordinated motion.

If volume of one or more pneumatic bellows actuator 130 changes due to movement of a user 101 wearing the exoskeleton system 100 (e.g., the user 101 moves a knee that causes expansion or contraction of a bellows actuator 130) the exoskeleton system 100 can be configured to sense a corresponding change in pressure of a working fluid volume 630, bellows actuator(s) 130, pneumatic chamber(s), or the like, and can move one or more pistons 640 accordingly to adjust the working fluid volume 630 to achieve a target pressure within one or more fluidic bellows actuators 130.

Various suitable fluidic actuators and systems can employ lead-screw compressor including actuators and/or exoskeleton systems shown and described in one or more of Applicant's U.S. patent application Ser. No. 15/082,824 entitled “LOWER-LEG EXOSKELETON SYSTEM AND METHOD,” which issued as U.S. Pat. No. 10,543,110; U.S. patent application Ser. No. 14/577,524 entitled “PNEUMATIC EXOMUSCLE SYSTEM AND METHOD,” which issued as U.S. Pat. No. 9,827,667; and U.S. patent application Ser. No. 15/953,296 entitled “LEG EXOSKELETON SYSTEM AND METHOD.” These patent applications are hereby incorporated by reference herein in their entirety and for all purposes.

By eliminating valves between a mechanical power source 660 (e.g., a motor) and one or more pneumatic actuator(s) 130 where mechanical energy is being transferred to a user 101 (e.g., via leg actuator unit(s) 110), irreversible energy losses due to uncontrolled air expansions can be largely eliminated in some examples. Furthermore, in some embodiments, energy used to create a pressure increase in one or more working fluid volume 630 can be partially recovered during pressure decrease. For example, backpressure on a piston 640 can create a load on the mechanical power source 660 which can be used to back-drive the mechanical power source 660, similar to regenerative braking. This can result in the mechanical power source 660 storing energy back into the system power source 516 (see FIG. 5). This can generate a net reduction in total energy consumption in various examples.

Eliminating valves in various examples as discussed herein can eliminate flow restrictions, which can be inherent in some valve designs. Reduced flow restrictions can mean that air can enter and exit one or more pneumatic actuators 130 of an exoskeleton system 100 with higher flow rates, which can be desirable. However, it should be noted that valves may not be a main flow restriction in some examples.

In some reciprocating compressor systems, the air pressure used to supply air to one or more pneumatic actuators 130 must be higher in the source than in the actuator(s) 130. A pressure differential can be required to induce flow across an inlet valve in such examples. The pressure differential required to induce flow across a valve-less pneumatic flow path of sufficient size can be negligible in some examples, meaning that the maximum pressure in a working fluid volume 630 can be the maximum pressure target in the pneumatic actuator(s) 130. By reducing the pressure increase in the system over such compressors, the temperature increase of air in the system can also be reduced. This can reduce temperature requirements of components in the flowpath, and can reduce the potential for energy loss due to heat transfer out of the system.

By eliminating inlet and/or exhaust valves in some examples of pneumatic actuators 130, (which can reduce energy consumption, and can reduce thermal mitigation requirements), a fluidic system (e.g., exoskeleton system 100) based around such a pressure control system can have fewer total components, fewer electromechanical actuators, and can require less energy storage for a given operational range. This can be desirable in various embodiments.

In some embodiments, a robotic exoskeleton system 100 does not use valves to seal one or more pneumatic actuators 130 in a pressurized state. In the event that a pneumatic actuator 130 is not moving, and a constant pressure (e.g., greater than atmospheric pressure) needs to be maintained, a mechanical power source 660 can hold a piston 640 stationary in some examples. Because a screw 650 that positions the piston 640 may be able to be back-driven, the force from the system pressure acting on the piston 640 must be counteracted by motor torque of the mechanical power source 660 in various embodiments. The mechanical power source 660 can exercise a holding torque to maintain pressure in some examples of a static system. This holding torque, in some examples, can consume electrical power while the exoskeleton system 100 is not conveying any actual mechanical power to the user 101 (though a constant force may still be maintained in one or more pneumatic actuators 130).

Consuming electrical power to maintain pressure in a static system can be a drawback of some types of systems compared to others. In a system with valves to seal one or more pneumatic bellows actuators 130, in various examples, no power needs to be consumed to maintain pressure in a static load case. The magnitude of this drawback can be highly application-dependent and may not be present in some embodiments. Accordingly, various embodiments can include valves between a pneumatic power transmission 600 and one or more pneumatic bellows actuators 130, which in some examples can aid in creating a static pressure in the one or more pneumatic bellows actuator 130.

Some preferred embodiments can use screw-driven pistons 640 to create pressure changes in a dynamic system. One functionality of the piston-side of such a system (e.g., a pneumatic transmission system 600) can be that such a system is analogous to a syringe. For example, in a soft-robotics application, the whole system can be analogous to using a large syringe to inflate and deflate a small balloon.

In various embodiments, a piston 640 can have a cross section that is not circular. The interaction of the broad regions of the piston circumference with the piston walls can be used to create the reaction torque on the piston 640, which can be required by a nut of the piston 640 to generate movement of the piston 640 via a lead screw 650. Such an interaction of a non-circular piston 640 can effectively serve as a counter-rotation feature, which can prevent the piston 640 from spinning with the nut. Such a non-circular design can eliminate the need for additional counter rotation features in the form of additional components, more sealing interfaces, more complex seals or components, or a combination thereof. However, some embodiments can comprise a circular piston having anti-rotation features such as a keyway, linear guide rail, or the like.

In various examples, working fluid volume 630 of an exoskeleton system 100 can be a single closed air volume consisting of, consisting essentially of, or comprising a pneumatic actuator 130 and a pneumatic transmission 600, connected by a single pneumatic tube or line 145. When installed on a user 101, the pneumatic actuator 130 can be positioned to convey force to the user 101 around a skeletal joint or a muscle group as discussed herein. The pneumatic transmission 600 can be carried on the user's back, torso, or on the portion of a limb closest to the user's torso, such as the upper thigh, or the like. The pneumatic line 145 in some examples can connect the pneumatic actuator 130 and pneumatic transmission 600 to create the single closed-air working fluid volume 630. However, some examples can comprise an over-pressure valve, bleed valves to allow atmospheric air into the system or quickly let air out of the system, and the like.

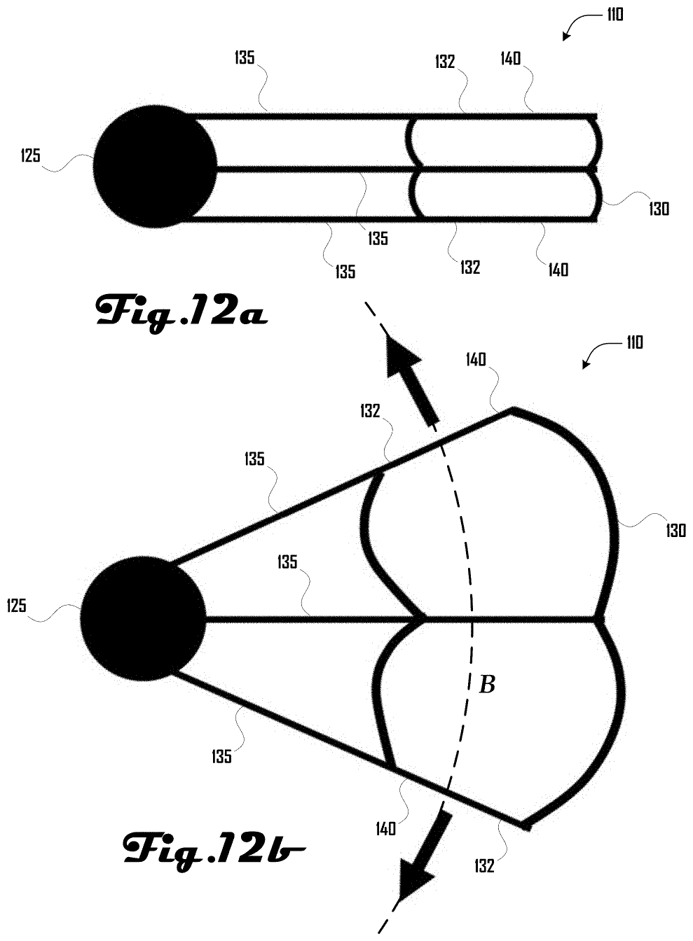

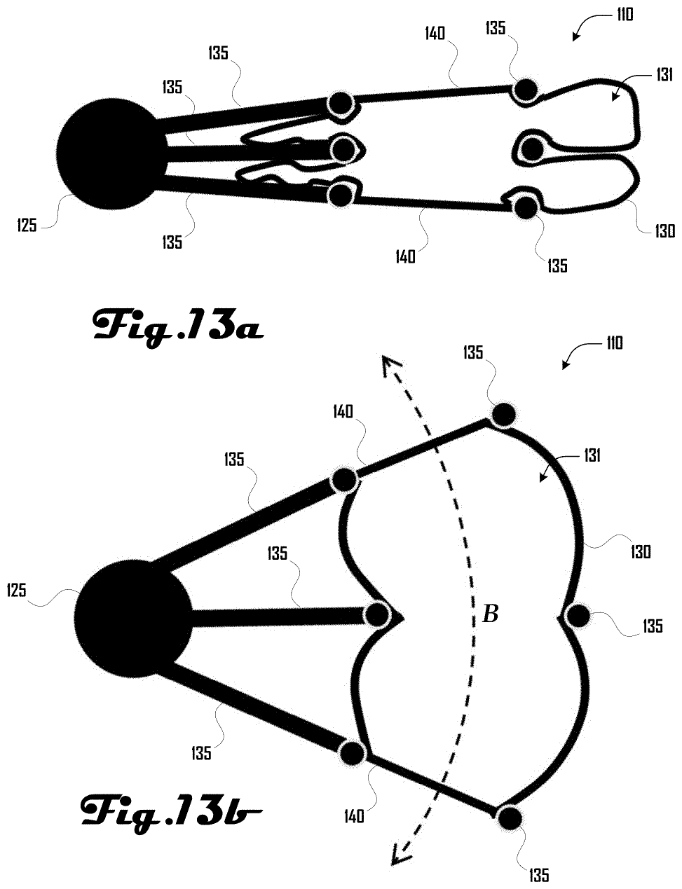

Turning to FIGS. 12a, 12b, 13a and 13b, examples of a leg actuator unit 110 can include the joint 125, bellows actuator 130, constraint ribs 135, and base plates 140. More specifically, FIG. 12a illustrates a side view of a leg actuator unit 110 in a compressed configuration and FIG. 12b illustrates a side view of the leg actuator unit 110 of FIG. 12a in an expanded configuration. FIG. 13a illustrates a cross-sectional side view of a leg actuator unit 110 in a compressed configuration and FIG. 13b illustrates a cross-sectional side view of the leg actuator unit 110 of FIG. 13a in an expanded configuration.

As shown in FIGS. 12a, 12b, 13a and 13b, the joint 125 can have a plurality of constraint ribs 135 extending from and coupled to the joint 125, which surround or abut a portion of the bellows actuator 130. For example, in some embodiments, constraint ribs 135 can abut the ends 132 of the bellows actuator 130 and can define some or all of the base plates 140 that the ends 132 of the bellows actuator 130 can push against. However, in some examples, the base plates 140 can be separate and/or different elements than the constraint ribs 135 (e.g., as shown in FIG. 1). Additionally, one or more constraint ribs 135 can be disposed between ends 132 of the bellows actuator 130. For example, FIGS. 12a, 12b, 13a and 13b illustrate one constraint rib 135 disposed between ends 132 of the bellows actuator 130; however, further embodiments can include any suitable number of constraint ribs 135 disposed between ends of the bellows actuator 130, including 1, 2, 3, 4, 5, 6, 7, 8, 9, 10, 15, 20, 25, 30, 50, 100 and the like. In some embodiments, constraint ribs can be absent.

As shown in cross sections of FIGS. 13a and 13b, the bellows actuator 130 can define a cavity 131 that can be filled with fluid (e.g., air), to expand the bellows actuator 130, which can cause the bellows to elongate along axis B as shown in FIGS. 12b and 13b. For example, increasing a pressure and/or volume of fluid in the bellows actuator 130 shown in FIG. 12a can cause the bellows actuator 130 to expand to the configuration shown in FIG. 12b. Similarly, increasing a pressure and/or volume of fluid in the bellows actuator 130 shown in FIG. 13a can cause the bellows actuator 130 to expand to the configuration shown in FIG. 13b. For clarity, the use of the term “bellows” is to describe a component in the described actuator unit 110 and is not intended to limit the geometry of the component. The bellows actuator 130 can be constructed with a variety of geometries including but not limited to a constant cylindrical tube, a cylinder of varying cross-sectional area, a 3-D woven geometry that inflates to a defined arc shape, and the like. The term ‘bellows’ should not be construed to necessary include a structure having convolutions.

Alternatively, decreasing a pressure and/or volume of fluid in the bellows actuator 130 shown in FIG. 12b can cause the bellows actuator 130 to contract to the configuration shown in FIG. 12a. Similarly, decreasing a pressure and/or volume of fluid in the bellows actuator 130 shown in FIG. 13b can cause the bellows actuator 130 to contract to the configuration shown in FIG. 13a. Such increasing or decreasing of a pressure or volume of fluid in the bellows actuator 130 can be performed by pneumatic system 520 and pneumatic lines 145 of the exoskeleton system 100, which can be controlled by the exoskeleton device 510 (see FIG. 5).

In one preferred embodiment, the bellows actuator 130 can be inflated with air; however, in further embodiments, any suitable fluid can be used to inflate the bellows actuator 130. For example, gasses including oxygen, helium, nitrogen, and/or argon, or the like can be used to inflate and/or deflate the bellows actuator 130. In further embodiments, a liquid such as water, an oil, or the like can be used to inflate the bellows actuator 130. Additionally, while some examples discussed herein relate to introducing and removing fluid from a bellows actuator 130 to change the pressure within the bellows actuator 130, further examples can include heating and/or cooling a fluid to modify a pressure within the bellows actuator 130.

As shown in FIGS. 12a, 12b, 13a and 13b, the constraint ribs 135 can support and constrain the bellows actuator 130. For example, inflating the bellows actuator 130 causes the bellows actuator 130 to expand along a length of the bellows actuator 130 and also cause the bellows actuator 130 to expand radially. The constraint ribs 135 can constrain radial expansion of a portion of the bellows actuator 130. Additionally, as discussed herein, the bellows actuator 130 comprise a material that is flexible in one or more directions and the constraint ribs 135 can control the direction of linear expansion of the bellows actuator 130. For example, in some embodiments, without constraint ribs 135 or other constraint structures the bellows actuator 130 would herniate or bend out of axis uncontrollably such that suitable force would not be applied to the base plates 140 such that the arms 115, 120 would not be suitably or controllably actuated. Accordingly, in various embodiments, the constraint ribs 135 can be desirable to generate a consistent and controllable axis of expansion B for the bellows actuator 130 as they are inflated and/or deflated.

In some examples, the bellows actuator 130 in a deflated configuration can substantially extend past a radial edge of the constraint ribs 135 and can retract during inflation to extend less past the radial edge of the constraint ribs 135, to extend to the radial edge of the constraint ribs 135, or not to extend less past the radial edge of the constraint ribs 135. For example, FIG. 13a illustrates a compressed configuration of the bellows actuator 130 where the bellows actuator 130 substantially extend past a radial edge of the constraint ribs 135 and FIG. 13b illustrates the bellows actuator 130 retracting during inflation to extend less past the radial edge of the constraint ribs 135 in an inflated configuration of the bellows actuator 130.

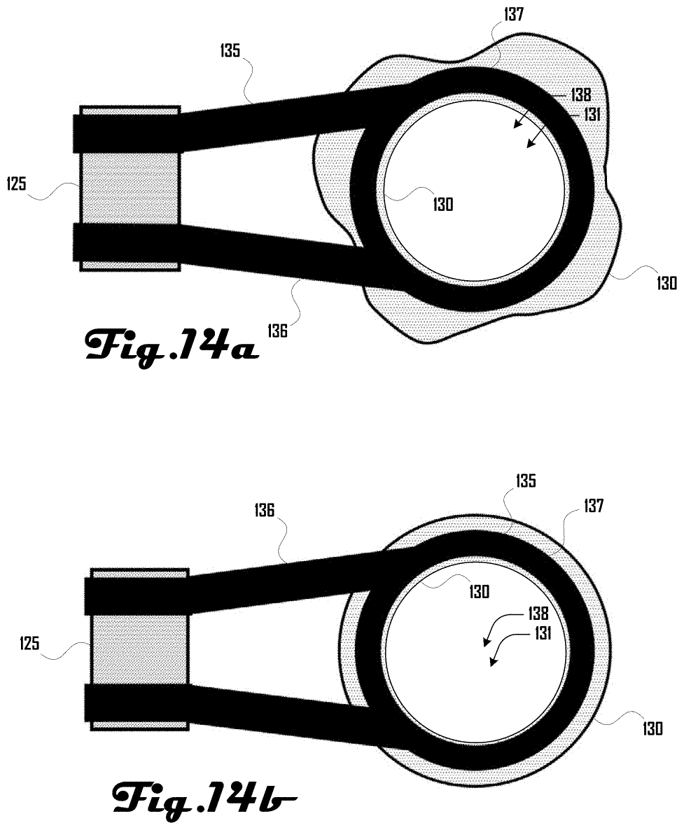

Similarly, FIG. 14a illustrates a top view of a compressed configuration of bellows actuator 130 where the bellows actuator 130 substantially extend past a radial edge of constraint ribs 135 and FIG. 14b illustrates a top view where the bellows actuator 130 retract during inflation to extend less past the radial edge of the constraint ribs 135 in an inflated configuration of the bellows actuator 130.

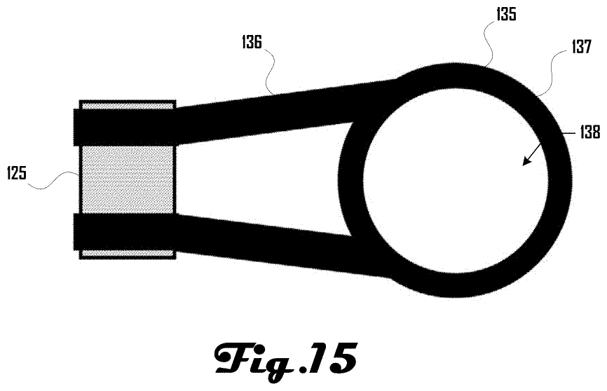

Constraint ribs 135 can be configured in various suitable ways. For example, FIGS. 14a, 14b and 15 illustrate a top view of an example embodiment of a constraint rib 135 having a pair of rib arms 136 that extend from the joint structure 125 and couple with a circular rib ring 137 that defines a rib cavity 138 through which a portion of the bellows actuator 130 can extend (e.g., as shown in FIGS. 13a, 13b, 14a and 14b). In various examples, the one or more constraint ribs 135 can be a substantially planar element with the rib arms 136 and rib ring 137 being disposed within a common plane.

In further embodiments, the one or more constraint ribs 135 can have any other suitable configuration. For example, some embodiments can have any suitable number of rib arms 136, including one, two, three, four, five, or the like. Additionally, the rib ring 137 can have various suitable shapes and need not be circular, including one or both of an inner edge that defines the rib cavity 138 or an outer edge of the rib ring 137.

In various embodiments, the constraining ribs 135 can be configured to direct the motion of the bellows actuator 130 through a swept path about some instantaneous center (which may or may not be fixed in space) and/or to prevent motion of the bellows actuator 130 in undesired directions, such as out-of-plane buckling. As a result, the number of constraining ribs 135 included in some embodiments can vary depending on the specific geometry and loading of the leg actuator unit 110. Examples can range from one constraining rib 135 up to any suitable number of constraining ribs 135; accordingly, the number of constraining ribs 135 should not be taken to limit the applicability of the invention. Additionally, constraining ribs 135 can be absent in some embodiments.

The one or more constraining ribs 135 can be constructed in a variety of ways. For example the one or more constraining ribs 135 can vary in construction on a given leg actuator unit 110, and/or may or may not require attachment to the joint structure 125. In various embodiments, the constraining ribs 135 can be constructed as an integral component of a central rotary joint structure 125. An example embodiment of such a structure can include a mechanical rotary pin joint, where the constraining ribs 135 are connected to and can pivot about the joint 125 at one end of the joint structure 125, and are attached to an inextensible outer layer of the bellows actuator 130 at the other end. In another set of embodiments, the constraining ribs 135 can be constructed in the form of a single flexural structure that directs the motion of the bellows actuator 130 throughout the range of motion for the leg actuator unit 110. Another example embodiment uses a flexural constraining rib 135 that is not connected integrally to the joint structure 125 but is instead attached externally to a previously assembled joint structure 125. Another example embodiment can comprise the constraint ribs 135 being composed of pieces of fabric wrapped around the bellows actuator 130 and attached to the joint structure 125, acting like a hammock to restrict and/or guide the motion of the bellows actuator 130. There are additional methods available for constructing the constraining ribs 135 that can be used in additional embodiments that include but are not limited to a linkage, a rotational flexure connected around the joint structure 125, and the like.

In some examples, a design consideration for constraining ribs 135 can be how the one or more constraining ribs 135 interact with the bellows actuator 130 to guide the path of the bellows actuator 130. In various embodiments, the constraining ribs 135 can be fixed to the bellows actuator 130 at predefined locations along the length of the bellows actuator 130. One or more constraining ribs 135 can be coupled to the bellows actuator 130 in various suitable ways, including but not limited to sewing, mechanical clamps, geometric interference, direct integration, and the like. In other embodiments, the constraining ribs 135 can be configured such that the constraining ribs 135 float along the length of the bellows actuator 130 and are not fixed to the bellows actuator 130 at predetermined connection points. In some embodiments, the constraining ribs 135 can be configured to restrict a cross sectional area of the bellows actuator 130. An example embodiment can include a tubular bellows actuator 130 attached to a constraining rib 135 that has an oval cross section, which in some examples can be a configuration to reduce the width of the bellows actuator 130 at that location when the bellows actuator 130 is inflated.

The bellows actuator 130 can have various functions in some embodiments, including containing operating fluid of the leg actuator unit 110, resisting forces associated with operating pressure of the leg actuator unit 110, and the like. In various examples, the leg actuator unit 110 can operate at a fluid pressure above, below or at about ambient pressure. In various embodiments, bellows actuator 130 can comprise one or more flexible, yet inextensible or practically inextensible materials in order to resist expansion (e.g., beyond what is desired in directions other than an intended direction of force application or motion) of the bellows actuator 130 beyond what is desired when pressurized above ambient pressure. Additionally, the bellows actuator 130 can comprise an impermeable or semi-impermeable material in order to contain the actuator fluid.

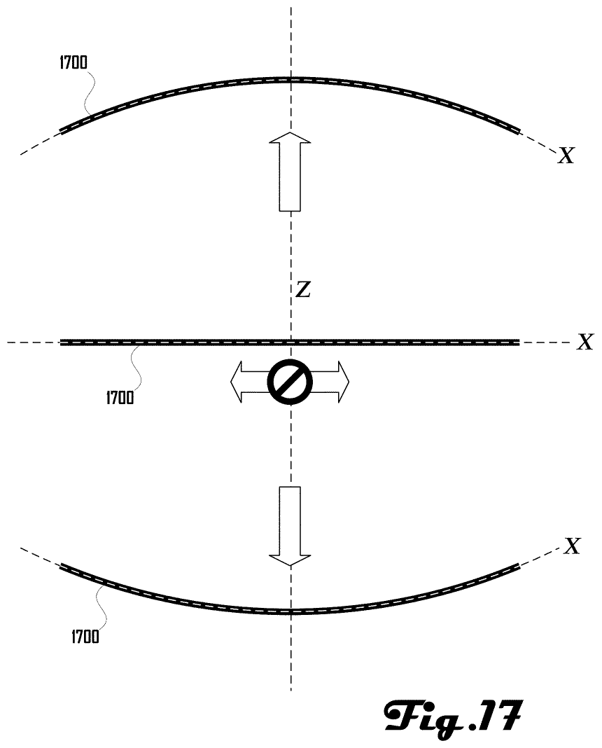

For example, in some embodiments, the bellows actuator 130 can comprise a flexible sheet material such as woven nylon, rubber, polychloroprene, a plastic, latex, a fabric, or the like. Accordingly, in some embodiments, bellows actuator 130 can be made of a planar material that is substantially inextensible along one or more plane axes of the planar material while being flexible in other directions. For example, FIG. 17 illustrates a side view of a planar material 1700 (e.g., a fabric) that is substantially inextensible along axis X that is coincident with the plane of the material 1700, yet flexible in other directions, including axis Z. In the example of FIG. 17, the material 1700 is shown flexing upward and downward along axis Z while being inextensible along axis X. In various embodiments, the material 1700 can also be inextensible along an axis Y (not shown) that is also coincident with the plane of the material 1700 like axis X and perpendicular to axis X.

In some embodiments, the bellows actuator 130 can be made of a non-planar woven material that is inextensible along one or more axes of the material. For example, in one embodiment the bellows actuator 130 can comprise a woven fabric tube. Woven fabric material can provide inextensibility along the length of the bellows actuator 130 and in the circumferential direction. Such embodiments can still be able to be configured along the body of the user 101 to align with the axis of a desired joint on the body 101 (e.g., the knee 103).

In various embodiments, the bellows actuator 130 can develop its resulting force by using a constrained internal surface length and/or external surface length that are a constrained distance away from each other (e.g. due to an inextensible material as discussed above). In some examples, such a design can allow the actuator to contract on bellows actuator 130, but when pressurized to a certain threshold, the bellows actuator 130 can direct the forces axially by pressing on the plates 140 of the leg actuator unit 110 because there is no ability for the bellows actuator 130 to expand further in volume otherwise due to being unable to extend its length past a maximum length defined by the body of the bellows actuator 130.

In other words, the bellows actuator 130 can comprise a substantially inextensible textile envelope that defines a chamber that is made fluid-impermeable by a fluid-impermeable bladder contained in the substantially inextensible textile envelope and/or a fluid-impermeable structure incorporated into the substantially inextensible textile envelope. The substantially inextensible textile envelope can have a predetermined geometry and a non-linear equilibrium state at a displacement that provides a mechanical stop upon pressurization of the chamber to prevent excessive displacement of the substantially inextensible textile actuator.

In some embodiments, the bellows actuator 130 can include an envelope that consists or consists essentially of inextensible textiles (e.g., inextensible knits, woven, non-woven, etc.) that can prescribe various suitable movements as discussed herein. Inextensible textile bellows actuator 130 can be designed with specific equilibrium states (e.g., end states or shapes where they are stable despite increasing pressure), pressure/stiffness ratios, and motion paths. Inextensible textile bellows actuator 130 in some examples can be configured accurately delivering high forces because inextensible materials can allow greater control over directionality of the forces.

Accordingly, some embodiments of inextensible textile bellows actuator 130 can have a pre-determined geometry that produces displacement mostly via a change in the geometry between the uninflated shape and the pre-determined geometry of its equilibrium state (e.g., fully inflated shape) due to displacement of the textile envelope rather than via stretching of the textile envelope during a relative increase in pressure inside the chamber; in various embodiments, this can be achieved by using inextensible materials in the construction of the envelope of the bellows actuator 130. As discussed herein, in some examples “inextensible” or “substantially inextensible” can be defined as expansion by no more than 10%, no more than 5%, or no more than 1% in one or more direction.

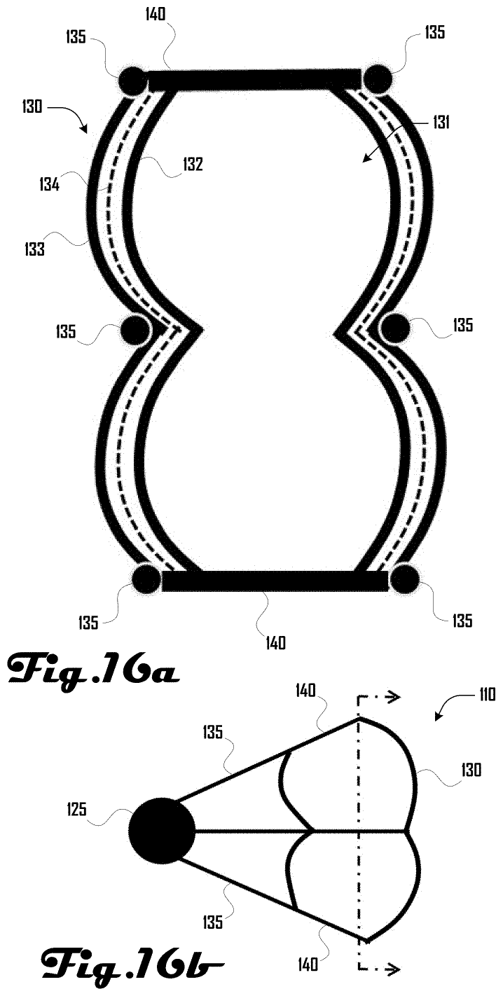

FIG. 16a illustrates a cross-sectional view of a pneumatic actuator unit 110 including bellows actuator 130 in accordance with another embodiment and FIG. 16b illustrates a side view of the pneumatic actuator unit 110 of FIG. 16a in an expanded configuration showing the cross section of FIG. 16a. As shown in FIG. 16a, the bellows actuator 130 can comprise an internal first layer 132 that defines the bellows cavity 131 and can comprise an outer second layer 133 with a third layer 134 disposed between the first and second layers 132, 133. Throughout this description, the use of the term “layer” to describe the construction of the bellows actuator 130 should not be viewed as limiting to the design. The use of ‘layer’ can refer to a variety of designs including but not limited to: a planar material sheet, a wet film, a dry film, a rubberized coating, a co-molded structure, and the like.

In some examples, the internal first layer 132 can comprise a material that is impermeable or semi-permeable to the actuator fluid (e.g., air) and the external second layer 133 can comprise an inextensible material as discussed herein. For example, as discussed herein, an impermeable layer can refer to an impermeable or semi-permeable layer and an inextensible layer can refer to an inextensible or a practically inextensible layer.

In some embodiments comprising two or more layers, the internal layer 132 can be slightly oversized compared to an inextensible outer second layer 133 such that the internal forces can be transferred to the high-strength inextensible outer second layer 133. One embodiment comprises a bellows actuator 130 with an impermeable polyurethane polymer film inner first layer 132 and a woven nylon braid as the outer second layer 133.

The bellows actuator 130 can be constructed in various suitable ways in further embodiments, which can include a single-layer design that is constructed of a material that provides both fluid impermeability and that is sufficiently inextensible. Other examples can include a complex bellows assembly that comprises multiple laminated layers that are fixed together into a single structure. In some examples, it can be necessary to limit the deflated stack height of the bellows actuator 130 to maximize the range of motion of the leg actuator unit 110. In such an example, it can be desirable to select a low-thickness fabric that meets the other performance needs of the bellows actuator 130.

In yet another embodiment, it can be desirable to reduce friction between the various layers of the bellows actuator 130. In one embodiment, this can include the integration of a third layer 134 that acts as an anti-abrasive and/or low friction intermediate layer between the first and second layers 132, 133. Other embodiments can reduce the friction between the first and second layers 132, 133 in alternative or additional ways, including but not limited to the use of a wet lubricant, a dry lubricant, or multiple layers of low friction material. Accordingly, while the example of FIG. 14a illustrates an example of a bellows actuator 130 comprising three layers 132, 133, 134, further embodiments can include a bellows actuator 130 having any suitable number of layers, including one, two, three, four, five, ten, fifteen, twenty five, and the like. Such one or more layers can be coupled along adjoining faces in part or in whole, with some examples defining one or more cavities between layers. In such examples, material such as lubricants or other suitable fluids can be disposed in such cavities or such cavities can be effectively empty. Additionally, as described herein, one or more layers (e.g., the third layer 134) need not be a sheet or planar material layer as shown in some examples and can instead comprise a layer defined by a fluid. For example, in some embodiments, the third layer 134 can be defined by a wet lubricant, a dry lubricant, or the like.

The inflated shape of the bellows actuator 130 can be important to the operation of the bellows actuator 130 and/or leg actuator unit 110 in some embodiments. For example, the inflated shape of the bellows actuator 130 can be affected through the design of both an impermeable and inextensible portion of the bellows actuator 130 (e.g., the first and second layer 132, 133). In various embodiments, it can be desirable to construct one or more of the layers 132, 133, 134 of the bellows actuator 130 out of various two-dimensional panels that may not be intuitive in a deflated configuration.

In some embodiments, one or more impermeable layers can be disposed within the bellows cavity 131 and/or the bellows actuator 130 can comprise a material that is capable of holding a desired fluid (e.g., a fluid impermeable first internal layer 132 as discussed herein). The bellows actuator 130 can comprise a flexible, elastic, or deformable material that is operable to expand and contract when the bellows actuator 130 are inflated or deflated as described herein. In some embodiments, the bellows actuator 130 can be biased toward a deflated configuration such that the bellows actuator 130 is elastic and tends to return to the deflated configuration when not inflated. Additionally, although bellows actuator 130 shown herein are configured to expand and/or extend when inflated with fluid, in some embodiments, bellows actuator 130 can be configured to shorten and/or retract when inflated with fluid in some examples. Also, the term “bellows” as used herein should not be construed to be limiting in any way. For example the term “bellows” as used herein should not be construed to require elements such as convolutions or other such features (although convoluted bellows actuator 130 can be present in some embodiments). As discussed herein, bellows actuator 130 can take on various suitable shapes, sizes, proportions and the like.

The bellows actuator 130 can vary significantly across various embodiments, so the present examples should not be construed to be limiting. One preferred embodiment of a bellows actuator 130 includes fabric-based pneumatic actuator configured such that it provides knee extension torque as discussed herein. Variants of this embodiment can exist to tailor the actuator to provide the desired performance characteristics of the actuators such as a fabric actuator that is not of a uniform cross-section. Other embodiments can use an electro-mechanical actuator configured to provide flexion and extension torques at the knee instead of or in addition to a fluidic bellows actuator 130. Various embodiments can include but are not limited to designs that incorporate combinations of electromechanical, hydraulic, pneumatic, electro-magnetic, or electro-static for positive power or negative power assistance of extension or flexion of a lower extremity joint.

The actuator bellows actuator 130 can also be located in a variety of locations as required by the specific design. One embodiment places the bellows actuator 130 of a powered knee brace component located in line with the axis of the knee joint and positioned parallel to the joint itself. Various embodiments include but are not limited to, actuators configured in series with the joint, actuators configured anterior to the joint, and actuators configured to rest around the joint.

Various embodiments of the bellows actuator 130 can include secondary features that augment the operation of the actuation. One such embodiment is the inclusion of user-adjustable mechanical hard end stops to limit the allowable range of motion to the bellows actuator 130. Various embodiments can include but are not limited to the following extension features: the inclusion of flexible end stops, the inclusion of an electromechanical brake, the inclusion of an electro-magnetic brake, the inclusion of a magnetic brake, the inclusion of a mechanical disengage switch to mechanically decouple the joint from the actuator, or the inclusion of a quick release to allow for quick changing of actuator components.

In various embodiments, the bellows actuator 130 can comprise a bellows and/or bellows system as described in related U.S. patent application Ser. No. 14/064,071 filed Oct. 25, 2013, which issued as U.S. Pat. No. 9,821,475; as described in U.S. patent application Ser. No. 14/064,072 filed Oct. 25, 2013; as described in U.S. patent application Ser. No. 15/823,523 filed Nov. 27, 2017; or as described in U.S. patent application Ser. No. 15/472,740 filed Mar. 29, 2017.

In some applications, the design of the fluidic actuator unit 110 can be adjusted to expand its capabilities. One example of such a modification can be made to tailor the torque profile of a rotary configuration of the fluidic actuator unit 110 such that the torque changes as a function of the angle of the joint structure 125. To accomplish this in some examples, the cross-section of the bellows actuator 130 can be manipulated to enforce a desired torque profile of the overall fluidic actuator unit 110. In one embodiment, the diameter of the bellows actuator 130 can be reduced at a longitudinal center of the bellows actuator 130 to reduce the overall force capabilities at the full extension of the bellows actuator 130. In yet another embodiment, the cross-sectional areas of the bellows actuator 130 can be modified to induce a desired buckling behavior such that the bellows actuator 130 does not get into an undesirable configuration. In an example embodiment, the end configurations of the bellows actuator 130 of a rotary configuration can have the area of the ends reduced slightly from the nominal diameter to provide for the end portions of the bellows actuator 130 to buckle under loading until the actuator unit 110 extends beyond a predetermined joint angle, at which point the smaller diameter end portion of the bellows actuator 130 would begin to inflate.

In other embodiments, this same capability can be developed by modifying the behavior of the constraining ribs 135. As an example embodiment, using the same example bellows actuator 130 as discussed in the previous embodiment, two constraining ribs 135 can fixed to such bellows actuator 130 at evenly distributed locations along the length of the bellows actuator 130. In some examples, a goal of resisting a partially inflated buckling can be combated by allowing the bellows actuator 130 to close in a controlled manner as the actuator unit 110 closes. The constraining ribs 135 can be allowed to get closer to the joint structure 125 but not closer to each other until they have bottomed out against the joint structure 125. This can allow the center portion of the bellows actuator 130 to remain in a fully inflated state which can be the strongest configuration of the bellows actuator 130 in some examples.

In further embodiments, it can be desirable to optimize the fiber angle of the individual braid or weave of the bellows actuator 130 in order to tailor specific performance characteristics of the bellows actuator 130 (e.g., in an example where a bellows actuator 130 includes inextensibility provided by a braided or woven fabric). In other embodiments, the geometry of the bellows actuator 130 of the actuator unit 110 can be manipulated to allow the robotic exoskeleton system 100 to operate with different characteristics. Example methods for such modification can include but are not limited to the following: the use of smart materials on the bellows actuator 130 to manipulate the mechanical behavior of the bellows actuator 130 on command; or the mechanical modification of the geometry of the bellows actuator 130 through means such as shortening the operating length and/or reducing the cross sectional area of the bellows actuator 130.

In further examples, a fluidic actuator unit 110 can comprise a single bellows actuator 130 or a combination of multiple bellows actuator 130, each with its own composition, structure, and geometry. For example, some embodiments can include multiple bellows actuator 130 disposed in parallel or concentrically on the same joint assembly 125 that can be engaged as needed. In one example embodiment, a joint assembly 125 can be configured to have two bellows actuator 130 disposed in parallel directly next to each other. The exoskeleton system 100 can selectively choose to engage each bellows actuator 130 as needed to allow for various amounts of force to be output by the same fluidic actuator unit 110 in a desirable mechanical configuration.

In further embodiments, a fluidic actuator unit 110 can include various suitable sensors to measure mechanical properties of the bellows actuator 130 or other portions of the fluidic actuator unit 110 that can be used to directly or indirectly estimate pressure, force, or strain in the bellows actuator 130 or other portions of the fluidic actuator unit 110. In some examples, sensors located at the fluidic actuator unit 110 can be desirable due to the difficulty in some embodiments associated with the integration of certain sensors into a desirable mechanical configuration while others may be more suitable. Such sensors at the fluidic actuator unit 110 can be operably connected to the exoskeleton device 610 (see FIG. 6) and the exoskeleton device 610 can use data from such sensors at the fluidic actuator unit 110 to control the exoskeleton system 100.

As discussed herein, various suitable exoskeleton systems 100 can be used in various suitable ways and for various suitable applications. However, such examples should not be construed to be limiting on the wide variety of exoskeleton systems 100 or portions thereof that are within the scope and spirit of the present disclosure. Accordingly, exoskeleton systems 100 that are more or less complex than the examples of FIGS. 1-5 are within the scope of the present disclosure.

Additionally, while various examples relate to an exoskeleton system 100 associated with the legs or lower body of a user, further examples can be related to any suitable portion of a user body including the torso, arms, head, legs, or the like. Also, while various examples relate to exoskeletons, it should be clear that the present disclosure can be applied to other similar types of technology, including prosthetics, body implants, robots, or the like. Further, while some examples can relate to human users, other examples can relate to animal users, robot users, various forms of machinery, or the like.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives. Additionally, elements of a given embodiment should not be construed to be applicable to only that example embodiment and therefore elements of one example embodiment can be applicable to other embodiments. Additionally, elements that are specifically shown in example embodiments should be construed to cover embodiments that comprise, consist essentially of, or consist of such elements, or such elements can be explicitly absent from further embodiments. Accordingly, the recitation of an element being present in one example should be construed to support some embodiments where such an element is explicitly absent.

What is claimed is:

1. An exoskeleton system comprising:
a left and right leg actuator unit configured to be respectively coupled to a left and right leg of a user, the left and right leg actuator units each including:
an upper arm and a lower arm that are rotatably coupled via a joint, the joint positioned at a knee of the user with the upper arm coupled about an upper leg portion of the user above the knee and with the lower arm coupled about a lower leg portion of the user below the knee, and
a fluidic bellows actuator that extends between the upper arm and lower arm;
a separate first and second pneumatic power transmission that each include:
a transmission body that defines a transmission chamber configured to hold a fluid, the transmission body having a first and second end,
a lead screw that extends along an axis X within the transmission body, the lead screw rotatably coupled at the first end of the transmission body, and
a piston that translates within the transmission chamber between the first and second ends of the transmission body via rotation of the lead screw, with translation of the piston within the transmission chamber changing a volume of the transmission chamber, the piston having a non-circular peripheral profile that engages an internal wall of the transmission body to generate a fluid-impermissible seal and prevents rotation of the piston within the transmission chamber,
a first and second mechanical power source respectively coupled to the lead screws of the first and second pneumatic power transmission, the first and second mechanical power sources configured to independently rotate the respective lead screws to cause the respective pistons to translate within the respective transmission bodies to change the volumes of the respective transmission cavities; and
a first and second fluid line, that respectively couple the first and second pneumatic power transmissions to a respective one of the fluidic bellows actuators of the left and right leg actuator units,
wherein the first fluid line fluidically couples the transmission chamber of the first pneumatic power transmission and the fluidic bellows actuators of the left leg actuator unit to define a first working fluid volume, and
wherein the second fluid line fluidically couples the transmission chamber of the second pneumatic power transmission and the fluidic bellows actuators of the right leg actuator unit to define a first working fluid volume.

2. The exoskeleton system of claim 1, wherein the first and second mechanical power sources are controlled by an exoskeleton device based at least in part on data obtained from a plurality of sensors including a plurality of pressure.

3. The exoskeleton system of claim 1, wherein the first and second mechanical power sources and the first and second pneumatic power transmissions are disposed within a backpack configured to be worn by the user.

4. The exoskeleton system of claim 1, wherein valves are absent from the fluidic bellows actuators of the left and right leg actuator units; wherein valves are absent from the first and second pneumatic power transmissions; and wherein valves are absent from the first and second fluid lines.

5. An exoskeleton system comprising:
a first and second fluidic bellows actuator;
a first and second pneumatic power transmission that each include:
a transmission body that defines a transmission chamber configured to hold a fluid, the transmission body having a first and second end,
a screw that extends along an axis X within the transmission body, the screw rotatably coupled at the first end of the transmission body, and
a piston that translates within the transmission chamber between the first and second ends of the transmission body via rotation of the screw, with translation of the piston within the transmission chamber changing a volume of the transmission chamber, the piston engaging an internal wall of the transmission body to generate a fluid-impermissible seal,
a first and second mechanical power source respectively coupled to the screws of the first and second pneumatic power transmission, the first and second mechanical power sources configured to independently rotate the respective screws to cause the respective pistons to translate within the respective transmission bodies to change the volumes of the respective transmission cavities;
a first fluid line that couples the first pneumatic power transmission to the first fluidic bellows actuator; and
a second fluid line that couples the second pneumatic power transmission to the second fluidic bellows actuator.

6. The exoskeleton system of claim 5, wherein the piston has a non-circular peripheral profile that engages an internal wall of the transmission body to generate a fluid-impermissible seal.

7. The exoskeleton system of claim 5, wherein the first fluid line fluidically couples the transmission chamber of the first pneumatic power transmission and the fluidic bellows actuators of the left leg actuator unit to define a first working fluid volume, and
wherein the second fluid line fluidically couples the transmission chamber of the second pneumatic power transmission and the fluidic bellows actuators of the right leg actuator unit to define a first working fluid volume.

8. The exoskeleton system of claim 5, further comprising a left and right joint actuator unit configured to be respectively coupled to a left and right joint of a user, the left and right joint actuator units respectively including the first and second fluidic bellows actuators.

9. The exoskeleton system of claim 5, wherein the first and second mechanical power sources and the first and second pneumatic power transmissions are disposed within a backpack configured to be worn by the user.

10. The exoskeleton system of claim 5, wherein valves are absent from the fluidic bellows actuators of the left and right joint actuator units; wherein valves are absent from the first and second pneumatic power transmissions; and wherein valves are absent from the first and second fluid lines.

11. An exoskeleton system comprising:
a fluidic actuator;
a power transmission that includes:
a transmission body that defines a transmission chamber configured to hold a fluid, the transmission body having a first and second end, and
a piston that translates within the transmission chamber between the first and second ends of the transmission body, with translation of the piston within the transmission chamber changing a volume of the transmission chamber,
a mechanical power source coupled to the power transmission configured to cause the piston to translate within respective transmission body to change the volume of the transmission cavity; and
a first fluid line that couples the power transmission to the fluidic actuator.

12. The exoskeleton system of claim 11, wherein a screw extends along an axis X within the transmission body, the screw rotatably coupled at the first end of the transmission body.

13. The exoskeleton system of claim 12, wherein the piston translates within the transmission chamber between the first and second ends of the transmission body via rotation of the screw.

14. The exoskeleton system of claim 12, wherein the mechanical power source is coupled to the screw of power transmission and configured to rotate the screw to cause the piston to translate within the transmission body to change the volume of the transmission cavity.

15. The exoskeleton system of claim 11 wherein the piston engages an internal wall of the transmission body to generate a fluid-impermissible seal.

16. The exoskeleton system of claim 11, wherein the piston has a non-circular peripheral profile.

17. The exoskeleton system of claim 11, wherein the fluid line fluidically couples the transmission chamber of the power transmission and the fluidic actuator to define a working fluid volume.

18. The exoskeleton system of claim 11, further comprising a joint actuator unit configured to be coupled to a joint of a user, the joint actuator unit including the fluidic actuator.

19. The exoskeleton system of claim 11, wherein the mechanical power source and the power transmission are disposed within a backpack configured to be worn by the user.

20. The exoskeleton system of claim 11, wherein valves are absent from the fluidic actuators; wherein valves are absent from the power transmission; and wherein valves are absent from the fluid lines.
